(19) United States
(12) Patent Application Publication
(10) Pub. No.: US 2018/0330060 A1
(43) Pub. Date: Nov. 15, 2018

(54) SYSTEMS AND METHODS FOR TRANSFORMING PATIENT DATA BY A HEALTHCARE INFORMATION PLATFORM

(71) Applicant: Clarity, LLC, Mobile, AL (US)

(72) Inventors: Brandon Biles, Fairhope, AL (US); Brad Pitts, Theodore, AL (US)

(73) Assignee: Clarity, LLC, Mobile, AL (US)

(21) Appl. No.: 15/805,002

(22) Filed: Nov. 6, 2017

Related U.S. Application Data
(60) Provisional application No. 62/506,558, filed on May 15, 2017.

(51) Int. Cl. G06F 19/00

(52) U.S. Cl. CPC G06F 19/322; G06F 19/3406; G06F 19/363; G06F 19/3431

(57) ABSTRACT

A healthcare information platform is provided that can aggregate and normalize healthcare information using different data formats from different sources when populating a health record for a patient in a database. The information in the database can be cross-referenced to enable a healthcare provider to analyze the information for an individual patient or a group of patients based on a variety of different criteria. The healthcare information platform can also evaluate and/or correlate one or more patients' genetic testing results with other healthcare information to determine risks for individual patients so that different treatments or drug targets can be provided as necessary.

### CROSS REFERENCE TO RELATED APPLICATION

This application claims the benefit of U.S. Provisional Patent Application No. 62/506,558, filed on May 15, 2017, and entitled “CLARITY PLATFORM with SureMed Module,” which application is incorporated herein by reference.

### BACKGROUND

The present application generally relates to a healthcare information platform. More specifically, the present application is directed to systems and methods for transforming patient data by a healthcare information platform.

Healthcare providers can obtain different types of information on a patient in the course of providing treatment to a patient. For example, a healthcare provider can obtain profile information (e.g., height, weight, age, gender, medications, medical history, etc.), laboratory information (e.g., toxicology reports, blood test reports, etc.), self-assessment information and/or genetic information on a patient. The patient information that is collected by or on behalf of the healthcare provider can be stored in a laboratory information management system (LIMS). The LIMS can enable the healthcare provider, associated staff members, and/or other authorized personnel to access, as needed, the stored information on the patient.

When a report or document with information on the patient is generated (e.g., a blood test report is completed), the information can be provided to the LIMS by the laboratory (or other entity) generating the report or document using the HL7 (Health Level 7) standard. The LIMS can then take the information from the report and associate the information with the patient. However, the HL7 standard is a non-normalized standard, which can result in differently laboratories or entities using different formats to provide the same type of information to the LIMS. The use of different formats for the information provided to the LIMS can result in problems when attempting to analyze the information for one patient and can be even more problematic when trying to analyze the information from multiple patients to identify trends and/or obtain demographic information. The use of multiple formats for the information makes analysis of the information difficult since some information may be overlooked in the analysis of the information because the information was not identified due to the use of a different format. For example, a healthcare provider may not be able to use the genetic information of a patient in assessing the patient's risk due to the patient data being in different formats and thus not being accessible from a single location.

### SUMMARY

The present application is directed to a healthcare information platform that can aggregate healthcare information from different sources using different data formats (e.g., HL7 reports, patient assessments, etc.) to provide a more complete health record for a patient. The healthcare information platform can convert or transform the healthcare information from the different source into a common format that is then stored in one or more databases. The healthcare information in the databases (including demographics information) can be cross-referenced to enable a healthcare provider or other personnel to analyze the healthcare information for an individual patient or a group of patients based on a variety of different criteria (e.g., region, medications, genetics, demographics, etc.). The healthcare information platform can also evaluate and/or correlate one or more patients' genetic testing results with other healthcare information (e.g., prescription history, medical history, toxicology reports, etc.) to determine risks for individual patients so that different treatments or drug targets can be provided as necessary.

The healthcare information platform can also incorporate therapy logic or software that includes one or more sets of policies and/or procedures that adhere closely with state and federal regulatory agency guidelines to provide education and resources to help combat different epidemics (e.g., the opioid misuse epidemic). The therapy logic can be used by physicians, office managers, and/or other healthcare providers to help verify patient suitability for particular types of therapy (e.g., chronic opioid therapy), train healthcare providers on how to identify and manage patients at high risk for abusing or diverting controlled substances and to reduce the likelihood of prescription drug abuse and diversion.

One advantage of the present application is that it enables a physician to have condensed, real-time information about their patients from several external system by joining information from toxicology results, clinical blood work, patient self-assessments, and personalized genetic profiles.

Another advantage of the present application is it can provide for internal clinic audits to give visibility and instructional opportunities to the healthcare provider on what is being done well and what can improve.

Still another advantage of the present application is that it can be used by physicians to drive better patient care and diagnosis, by office managers and staff to streamline the reporting process, and by patients to better understand the effects of medications based on their personal genetic information.

An advantage of the present application is that it enables physicians to discover the most effective medication for different diagnoses based on patient demographic and genetic markers.

Another advantage of the present application is that is provides a tool to pharmaceutical and insurance representatives to see real results by region, demographic or medication to better shape drug policy and better refine the manufacturing process.

A further advantage of the present application is that it can be applied to the field of chronic opioid therapy.

Other features and advantages of the present application will be apparent from the following more detailed description of the identified embodiments, taken in conjunction with the accompanying drawings which show, by way of example, the principles of the application.

### BRIEF DESCRIPTION OF THE DRAWINGS

FIG. 1 is a block diagram showing an embodiment of a patient information system.

FIG. 2 is a block diagram showing an embodiment of the server of FIG. 1.

FIG. 3 shows an embodiment of a process for a healthcare provider to select assessments for a patient.

FIGS. 4 and 5 show different pages of an embodiment of a user interface for entering patient information.

FIGS. 6-8 show different pages of an embodiment of a user interface for selecting assessments for a patient.

FIG. 9 shows a page of an embodiment of a user interface for confirming patient information.

FIGS. 10-12 show pages of an embodiment of a user interface for a patient showing different assessment question types.

FIG. 13 shows a page of an embodiment of a user interface for a physician showing search results.

FIGS. 14-17 show pages of an embodiment of a user interface for a physician showing patient details.

FIG. 18 shows an embodiment of a process for initiating a care continuity program for a patient undergoing a preselected therapy.

FIG. 19 shows a page of an embodiment of a user interface for a physician showing patient details related to a care continuity program.

FIG. 20 shows an embodiment of a process for auditing healthcare information of a patient.

Wherever possible, the same reference numbers are used throughout the drawings to refer to the same or like parts.

### DETAILED DESCRIPTION

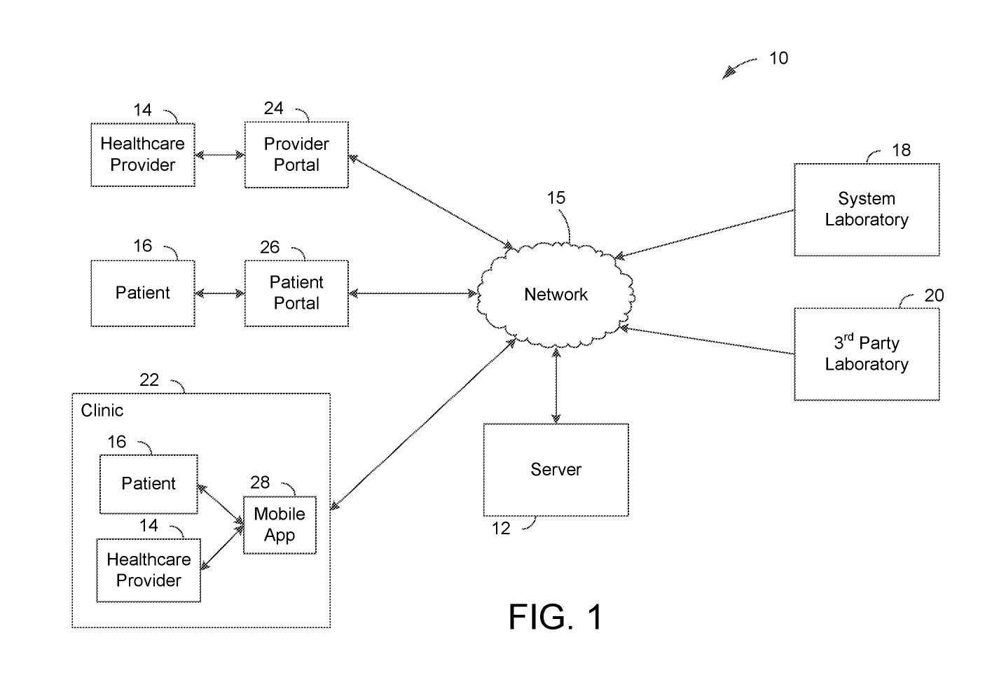

FIG. 1 shows an embodiment of a patient information system 10. The system 10 includes a server 12 with a healthcare information platform that communicates, via network 15, with one or more healthcare providers 14, one or more patients 16, one or more system laboratories 18, one or more third (3^{rd}) party laboratories 20 and/or one or more clinics 22. The healthcare provider 14 can access the server 12 and healthcare information platform via a provider portal 24. The patient 16 can access the server 12 and healthcare information platform via a patient portal 26. The clinic 22 can have one or more hand-held or mobile devices (e.g., a tablet computer or smartphone) that can be used by patients 16 and/or healthcare providers 14 to access the server 12 and healthcare information platform via a mobile app (application) 28 on the hand-held device. In one embodiment, the clinic 22 may also have one or more provider portals 24 for healthcare providers 14 to access the server 12 and healthcare information platform. The system laboratory 18 and the third party laboratory 20 can provide laboratory results (e.g., blood test results, toxicology results, genetic profiles, etc.) to the server 12 and healthcare information platform.

As information is received by the server 12 and healthcare information platform from the provider portal 24, the patient portal 26, the mobile app 28, the system laboratory 18 and the third party laboratory 20, the healthcare information platform can link the received information with the corresponding patient to which the information pertains. The server 12 and healthcare information platform can then provide some or all of the information collected on a particular patient to the healthcare provider 14 via the provider portal 24 or, in some embodiments, the patient 16 via the patient portal 26.

The provider portal 24 can be any device communicatively coupled to the network 15 and capable of exchanging (i.e., sending and receiving) instructions, data and/or information with the server 12 or another device connected to network 15. The provider portal 24 can provide an interface that permits the healthcare provider 14 to enter information associated with a patient to be stored at the server 12 and healthcare information platform and receive information associated with a patient from the server 12 and healthcare information platform. The “provider” interface can be executed by one or both of the server 12 and the provider portal 24. If the server 12 is used to execute at least a portion of the provider interface, the corresponding portions of the provider interface executed by the server 12 can be sent to the provider portal 24 via network 15.

In one embodiment, the provider portal 24 can be a computing device with a graphical user interface (or other suitable interface) that can receive information entered by the healthcare provider 14 and display information to the healthcare provider 14. The computing device can be, but is not limited to, a desktop, laptop or tablet computer, a hand-held device, such as a cellular telephone (e.g., a smartphone), and/or an attachable, wearable, implantable or non-invasive computer or device. The computing device used to provide the provider portal 24 can have one or more input devices to permit the healthcare provider 14 enter data and/or information and one or more output devices to permit the healthcare provider 14 to display or receive data and/or information. In one embodiment, the computing device used to provide the provider portal 24 can include a touch screen interface that can both display content received from the server 12 and receive touch inputs from the healthcare provider 14.

The patient portal 26 can be any device communicatively coupled to the network 15 and capable of exchanging (i.e., sending and receiving) instructions, data and/or information with the server 12 and healthcare information platform or another device coupled to the network 15. The patient portal 26 can provide an interface that permits the patient 16 to enter information about himself or herself to be stored at the server 12 and healthcare information platform and receive information about himself or herself from the server 12 and healthcare information platform. The “patient” interface can be executed by one or both of the server 12 and the patient portal 26. If the server 12 is used to execute at least a portion of the patient interface, the corresponding portions of the patient interface executed by the server 12 can be sent to the patient portal 26 via network 15.

In one embodiment, the patient portal 26 can be a computing device and a graphical user interface (or other suitable interface) that can receive information entered by the patient 16 and display information to the patient 16. The computing device can be, but is not limited to, a desktop, laptop or tablet computer, a hand-held device, such as a cellular telephone (e.g., a smartphone) or portable gaming device, a television, a video game system, a still and/or video camera, and/or an attachable, wearable, implantable or non-invasive computer or device. The computing device used to provide the patient portal 26 can have one or more input devices to permit the patient 16 enter data and/or information and one or more output devices to permit the patient 16 to display or receive data and/or information. In one embodiment, the computing device of the patient portal 26 can include a touch screen interface that can both display content received from the server 12 and receive touch inputs from the patient 16.

The network 15 can be the Internet and use the transmission control protocol/Internet protocol (TCP/IP) for communication in an embodiment. However, in other embodiments, the network 20 may be an Intranet, a local area network (LAN), a wide area network (WAN), a near field communication (NFC) network, or any other type of communication network using one or more communication protocols. In one embodiment, the server 12 can communicate over network 15 via HTTPS (hypertext transfer protocol secure) using SSL (secure sockets layer) for all data transmission and web traffic.

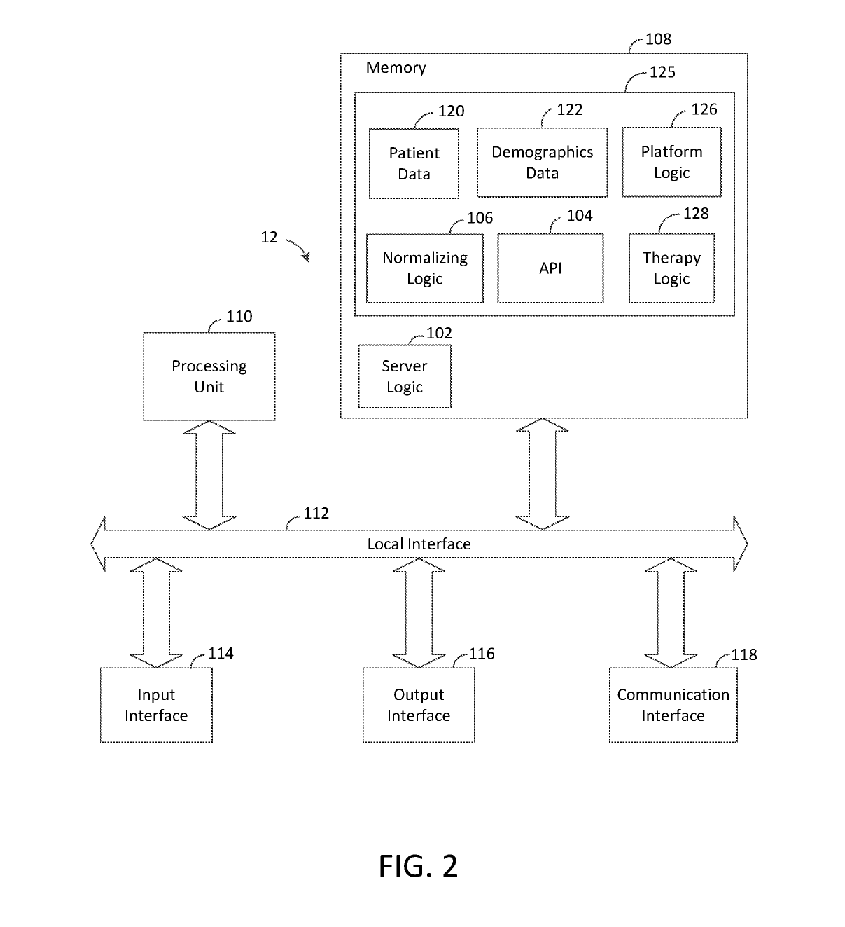

FIG. 2 shows an embodiment of the server 12. The server 12 may be implemented as one or more general or special-purpose computers, such as a laptop, hand-held (e.g., smartphone), desktop, or mainframe computer. The server 12 can include logic 102, referred to herein as “server logic,” for generally controlling the operation of the server 12, including communicating with the provider portal 24, the patient portal 26, the system laboratory 18, the third party laboratory 20 and the mobile app 28 of the patient information system 10. The server 12 can also include a healthcare information platform 125 to receive, process, analyze and distribute healthcare information on patients 16. The healthcare information platform 125 includes logic 126, referred to herein as “platform logic,” for generally controlling the operations of the healthcare information platform 125. The healthcare information platform 125 also includes an application programming interface (API) 104 to facilitate data transfer from the provider portal 24, the patient portal 26, the system laboratory 18, the third party laboratory 20 and the mobile app 28 to the healthcare information platform 125. In addition, the healthcare information platform 125 can include normalizing logic to convert data received by the API 104, as necessary, to place the data in the proper format for storage in the healthcare information platform 125 and therapy logic 128 to provide policies and procedures for implementing one or more therapies to patients 16.

The server logic 102, the platform logic 126, the therapy logic 128, the API 104 and the normalizing logic 106 can be implemented in software, hardware, firmware or any combination thereof. In the server 12 shown in FIG. 2, the server logic 102, the platform logic 126, the therapy logic 128, the API 104 and the normalizing logic 106 are implemented in software and stored in memory 108 of the server 12. Note that the server logic 102, the platform logic 126, the therapy logic 128, the API 104 and the normalizing logic 106, when implemented in software, can be stored and transported on any non-transitory computer-readable medium for use by or in connection with an instruction execution apparatus (e.g., a microprocessor) that can fetch and execute instructions. In the context of this application, a “computer-readable medium” can be any device, system or technique that can contain or store a computer program for use by or in connection with an instruction execution apparatus.

The server 12 includes at least one conventional processing unit 110, which has processing hardware for executing instructions stored in memory 108. As an example, the processing unit 110 may include a digital signal processor or a central processing unit (CPU). The processing unit 110 communicates to and drives the other elements within the server 12 via a local interface 112, which can include at least one bus. In other embodiments, the server 12 can include multiple processing units to assist with the processing of data. Furthermore, an input interface 114, for example, a keyboard, a mouse, touchscreen, sensor or any other interface device or apparatus, can be used to input data from a user of the server 12, and an output interface 116, for example, a printer, monitor, liquid crystal display (LCD), or other display apparatus, can be used to output data to the user of the server 12. Further, a communication interface 118, such as at least one modem, may be used to communicate data over the network 15.

As shown by FIG. 2, the healthcare information platform 125 has patient data 120 can be stored in memory 108 or other machine-readable media at the server 12. The patient data 120 can include information associate with a patient received from the provider portal 24, the patient portal 26, the system laboratory 18, the third party laboratory 20 and/or the mobile app 28. The healthcare information platform 125 can also have demographics data 122 stored in memory 108. In one embodiment, the demographics data 122 can be a copy of the patient data 120, but may include data different from the patient data 102 in other embodiments. The patient data 120 and the demographics data 122 can each be stored in one or more databases. The database(s) storing the patient data 120 and the demographics data 122 can use at-rest encryption in one embodiment.

In an exemplary embodiment, the healthcare information platform 125 can be hosted on a Microsoft Azure platform to allow for system redundancy, load balancing across multiple servers and good “uptime” performance. Both the mobile app 28, patient portal 26 and/or the provider portal 24 can leverage the web service based API 104 to push and pull information from the database(s) storing the patient data 120 and the demographics data 122. Each call from the provider portal 24, patient portal 26 or mobile app 28 through the API 104 can be authenticated with a JWT (JSON Web Token), an oAuth web security standard, in order to balance HIPAA compliant validation of the sender with speed and performance in the healthcare information platform 125. A token is generated during the initial logon to the provider portal 24, patient portal 26 or mobile app 28 and is re-used throughout its life cycle to reduce calls to the authentication segment of the API 104.

In an embodiment, the database(s) for the patient data 120 and the demographics data 122 can utilize a normalized, MS-SQL (Microsoft Structured Query Language) database format, but other database formats may be used in other embodiments. Each piece of information in the database can be stored in a separate table and linked using primary key identifiers and reference fields. The use of primary key identifiers and reference fields in the tables enables the healthcare information platform 125 to cross-reference and join multiple tables and pieces of information using the smallest number of access calls while permitting disparate pieces of information to be updated without impacting the larger structure of the healthcare information platform 125. For example, the healthcare information platform 125 can cross-reference patient toxicology results with both genetic markers and the patient's prescribed medication list for use by the healthcare provider 14.

The demographics data 122 can be used for demographics analysis of the patient information in one embodiment. However, in other embodiments, the demographics data 122 can be used in performing other types of analysis and/or for other purposes (e.g., data backup). The demographics data 122 can be periodically updated (e.g., hourly, daily, etc.) to reflect changes in the patient data 120 in one embodiment. While the patient data 120 and the demographic data 122 are shown in FIG. 2 as stored in memory 108, in other embodiments, the patient data 120 and/or the demographic data 122 can be stored in other memory devices and/or other computing devices that are incorporated in server 12.

In an exemplary embodiment, the demographics data 122 can be used for analytics and reporting metrics. The patient's demographic information (e.g., age, gender, ethnicity, and location) can be captured during the assessment and lab work process. The demographic information can be cross referenced with lab work results, type and duration of medications, and the patient's genetic report to create a multi-variable system used to explore and define drug usage and success rates in a human readable form. The healthcare platform 125 can be used to link together disparate pieces of information that may escape a single physician's notice in order to provide a comprehensive and easy to understand report of a medication's impact to a target region or genetic demographic. The results from the demographics analysis can be used to help better direct pharmaceutical development, shape insurance coverages to specific genetic markers in individuals, and better inform physicians in the diagnostic process. For example, as trends emerge in the data, policy shapers and drug manufacturers can respond more accurately because of the genetic information backing the analytic output. Specific drug success rates by gender or ethnicity can be explored in smaller and more specific sub-groups based on the various genetic markers and their associated metabolic rates, enabling the discovery of previously unknown causations and treatment methods, with the end product of a more intelligent and successful drug policy and treatment plan for individual patients and a more comprehensive understanding of the market environment for the pharmaceutical and insurance representatives.

The API 104 provides for all data transfer into or out of the database(s) storing the patient data 120 and/or the demographics data 122. In one embodiment, the API 104 can be a web-based REST (representational state transfer) API that uses HTTP (hypertext transfer protocol) requests to manipulate (e.g., read, write, delete, etc.) data in the database(s) for the patient data 120 and/or the demographics data 122. In another embodiment, the API 104 can use SOAP (simple object access protocol) technology for data transfer. In one embodiment, each message transmitted to or from the API 104 can be secured with an implementation of the JWT (JSON Web Token) oAuth security standard, although other security standards can be used in other embodiments.

Each of the provider portal 24, the patient portal 26 and the mobile app 28 can include a shared reference to the API 104 to ensure message formatting and data processing is handled uniformly across the entire system 10. Updates and improvements to the API 104 are likewise distributed to all components (e.g., the provider portal 24, the patient portal 26 and the mobile app 28) as the updates are completed.

Signing in (or accessing) the server 12 and healthcare information platform 125 is controlled through the shared API 104 for the provider portal 24, the patient portal 26 and the mobile app 28. Users of the healthcare information platform 125 (e.g., healthcare providers 14 or patients 16) can be identified through a combination of usernames, passwords, pin codes, and birthdates in one embodiment. However, in other embodiments, other types of information can be used for the identification of the users. Each user has a corresponding security role that is contained within a separate table within the database(s), thereby segregating information should one table be compromised or if a design flaw is discovered. The security role for the user can control access to different segments of data in the healthcare information platform 125 and can change the visualizations provided to the user in the provider portal 24, the patient portal 26 or the mobile app 28. For example, the access to the mobile app 28 can be limited to clinic level users or patient level users, access to the provider portal 24 can be limited to clinic and physician level users, and access to the patient portal 26 can be limited to patient level users.

In one embodiment, all user passwords can be encrypted by the healthcare information platform 125 using a variant of the Blowfish cypher with a variant number of work passes (between 7-10) to further enhance the hashing complexity. In addition, a 32 byte RNG (Random Number Generator) salt can be added to each password to further obscure the original value. The RNG salt can be used to hash and compare the passwords from any logon attempts to verify the correct credentials before giving access to a user account. In addition, all elements and control methods of the API 104 can be designed to provide ZDF (Zero Data Feedback), if accessed without the proper credentials to prevent any unauthorized access to the database(s) storing the patient data 120 and the demographics data 122 or other components of the healthcare information platform 125.

Access to the database(s) storing the patient data 120 and the demographics data 122 by a user can be facilitated by an implementation of the JWT oAuth security standard. After signing in, the user's account credentials, role permissions, and a signed token are returned to the provider portal 24, the patient portal 26 or the mobile app 28 and used to validate all communication during the session. The token can be validated during each request to the API 104, with any modifications or tampering resulting in blocked access from the server 12. In addition, each token can include a built in TTL (Time to Live) expiration, ensuring a level of protection for an unattended workstation or long periods of inactivity.

In an exemplary embodiment, the healthcare information platform 125 can store a user's logon information for any integrated third-party platforms in the healthcare information platform 125, in addition to a user's credentials for the healthcare information platform 125. By storing the user's logon information for third-party platforms, the healthcare information platform 125 can save on redundant calls to third-party platforms or external systems when a logon is needed and provides the framework for a SSO (single sign-on) experience. When logging in, any necessary SSO information is temporarily cached within the user's session. The caching of the SSO information enables the SSO to take effect when needed without additional calls to the API 104 or third-party platforms.

In one embodiment, to increase the speed of the response to user requests and reduce the amount of server resources required, multiple calls to the database(s) storing the patient data 120 and the demographics data 122 can be performed in a single API call. By having multiple database calls in a single API call enables the healthcare information platform 125 to open only one connection into the database(s) storing the patient data 120 and the demographics data 122, perform all necessary operations while that connection is open, then close the connection and free server resources when processing is completed. The use of one connection for multiple database calls ensures a connection is only opened when necessary and prevents excessive memory usage on the server 12.

Referring back to FIG. 1, the system laboratory 18 and the third party laboratory 20 can provide information on patients to the server 12 and the healthcare information platform 125 for storage in the database(s) storing the patient data 120 and the demographics data 122. In one embodiment, the system laboratory 18 can provide the information on patients to the server 12 in a recognized or normalized format for incorporation into the database(s) storing the patient data 120 and the demographics data 122, while the third party laboratory can provide the information on patients to the server 12 in any format that does not entirely correspond to the recognized format required by the database(s) storing the patient data 120 and the demographics data 122.

In one embodiment, the information associated with patients provided by the third party laboratory 20 can be non-normalized HL7 data. The server 12 can obtain non-normalized HL7 data, such as toxicology reports, blood test results and/or clinical results on patients, from the third party laboratory 20 by an automatically triggered SFTP (secure file transfer protocol) process. Once the information is received by the server 12, the normalization logic 106 can convert the HL7 data from the third party laboratory 20 into the format for insertion into the database(s) storing the patient data 120 and the demographics data 122 by executing a parsing process that identifies and flags high-risk and unusual results with a single pass of the non-normalized HL7 data. The flagged results or lines are collected and the remaining results are submitted in a normalized or recognized format to the database(s) storing the patient data 120 and the demographics data 122, at which time the corresponding results are associated with respective data points (e.g., patient, collected location, healthcare provider, etc.) and stored for later access. In addition, the normalization logic 106 can convert JSON (Javascript Object Notation) formatted medication lists received from the provider portal 24, the patient portal 26 or the mobile app 28 into the format for insertion into the database(s) storing the patient data 120 and the demographics data 122.

Additional information from toxicology reports, blood test results and/or clinical results can be submitted to the server 12 as a graphical report. In one embodiment, the graphical report can be in the PDF format, but other formats can be used in other embodiments. The normalization logic 106 can execute OCR (optical character recognition) and text parsing on the graphical report to identify information missing from the associated non-normalized HL7 file received by SFTP. A parsing process executed by the normalization logic 106 scans through the resulting text from the graphical report, then identifies and flags high-risk and unusual results in a single pass. The flagged results or lines can be collected and the remaining results can be submitted in a normalized or recognized format to the database(s) storing the patient data 120 and the demographics data 122, at which time the results are associated with respective data points (e.g., patient, collected location, healthcare provider, etc.) and stored for later access.

In an exemplary embodiment, the normalization logic 106 can process HL7 files (e.g., files with patient details and toxicology/clinical bloodwork results) with a parser in order to better search and track patient details over time. The parser can determine if the file(s) are related to a new or existing patient in the system and create appropriate records. In addition, the parser can translate the lab work results in a file into a normalized format for storage. Further, the parser can find and update any existing genetic records for the patient to create a consistent medication list. The healthcare information platform 125 can receive new HL7 files sent by a 3rd party laboratory or system 20 through a SFTP (secure file transfer protocol) server. An HL7 file can be referred to as a ‘message’, with each line considered a ‘segment’. Each segment begins with a codified segment identifier (id).

The parser of the normalization logic 106 can pull in all available messages from the third party laboratory 20 at the SFTP server and then, for each of message, scan in all lines and categorize the lines by specific ids, starting with the patient identifier and working down through the type of lab work and the corresponding results. At each step of the process, validation is done in the database(s) storing the patient data 120 and the demographics data 122 to either append the information to existing records or create new records, as appropriate, in a normalized format in order to complete the HL7 parsing in the fewest steps possible. When the HL7 message is fully processed, the message is removed from the SFTP server and the next message available begins to process. In one embodiment, the process can be repeated at a predetermined time period (e.g., every ten minutes) in order to save system resources and cut down on overall runtime.

The normalization logic 106 can be used, as needed, to convert data and/or information received from the provider portal 24, the patient portal 26, the mobile app 28, the system laboratory 18 and the third party laboratory 20 into a common format for insertion into the database(s) storing the patient data 120 and the demographics data 122. By providing data and/or information in a common format to the database(s), the data and/or information for each patient can be cross-referenced such that a healthcare provider 14 or the patient 16 can access any of the data and/or information regarding one or more patients from a single access point.

Genetic results and risk levels from the system laboratory 18 and/or the third party laboratory 20 can be provided to the server 12 in a two-part process. The raw data and medical processing is synthesized on an external system at the system laboratory 18 and/or the third party laboratory 20, which external system automatically triggers the notification to the server 12 that the results are available through a file transmitted by SFTP. The transmitted file identifies the patient 16, collected location (i.e., the system laboratory 18 and/or the third party laboratory 20), and healthcare provider 14, in addition to providing the synthesized results. The synthesized results, including risk level and problematic existing prescriptions is pulled by the healthcare information platform 125 on demand through a FHIR (Fast Healthcare Interoperability Resources) web based API incorporated into API 104. Patient self-assessment information can be submitted directly to the database(s) storing the patient data 120 and the demographics data 122 through the API 104 from either the mobile app 28 or the patient portal 26.

In one embodiment, the mobile app 28 can be used to capture patient self-assessments. The mobile app 28 can be executed on any hand-held or mobile device provided by a clinic 22. However, in other embodiments, the mobile app 28 may be executed on other hand-held or mobile devices that are not provided by the clinic 22. For example, the mobile app 28 may be executed on the patient's personal hand-held or mobile device. In one embodiment, the hand-held or mobile device can be any model of iPad running iOS version 8 or above.

The mobile app 28 can incorporate several standardized mental health assessments that have been approved by corresponding governing bodies such as the WHO (World Health Organization) or APA (American Psychological Association). In one embodiment, the mobile app 28 can provide 13 standardized mental health assessments. For example, the mobile app 28 can include: an AUDIT (Alcohol Use Disorders Identification Test) assessment for alcohol use; a PSEQ (Pain Self Efficacy Questionnaire) assessment for pain efficacy; an ASRS (Adult ADHD Self-Report Scale) assessment for adult ADHD (attention-deficit/hyperactivity disorder); a SOAPP-R (Screener and Opioid Assessment for Patients with Pain Revised) assessment for opioid use and pain; a COMM (Current Opioid Misuse Measure) assessment for opioid misuse; a BDSS (Bipolar Disorder Symptom Scale) assessment for bipolar disorder; a CESD-R (Center for Epidemiologic Studies Depression Scale) assessment for depression; a CRAFFT (Car, Relax, Alone, Forget, Friends, Trouble) assessment for substance-related risks and problems in adolescents; a EPDS (Edinburgh Postnatal Depression Scale) assessment for postnatal depression; a GAD-7 (Generalized Anxiety Disorder-7) assessment for anxiety; an ORT (Opioid Risk Tool) assessment for opioid use; a PCL-C (PTSD Checklist-Civilian Form) assessment for PTSD (post-traumatic stress disorder); and a PHQ-9 (Patient Health Questionnaire) assessment for patient health. However, in other embodiments, the mobile app 28 can provide more or less than 13 standardized mental health assessments.

The healthcare provider 14 (e.g., physician) can select the particular assessments to be completed for a particular patient 16 in order to tailor the experience to each patient's specific needs. The selected assessments by the healthcare provider 14 can then be provided to the patient 16 for completion via the mobile app 28 (or the patient portal 26). In one embodiment, the healthcare provider 14 can select the assessments for the patient 16 with the provider portal 24 and the selected assessments are then presented to the patient when the patient accesses the mobile app 28 or the patient portal 26. In another embodiment, the healthcare provider 14 can select the assessments for the patient 16 directly in the mobile app 28 (provided by the corresponding hand-held device) before presenting the hand-held device to the patient 16 for completion of the assessments.

In addition, the server 12 can predefine several collections of related assessments, sometimes referred to as “Batteries,” to speed up the assessment selection process for the healthcare provider 14. For example, the server 12 can pre-define, for selection by the healthcare provider 14, the following batteries: an Annual Screening Audit: including the GAD-7, PHQ-9, and AUDIT assessments; a Variable Pain Suite including the SOAPP-R, and COMM assessments; the Bipolar Suite including the BDSS, CESD-R, GAD-7, and PHQ-9 assessments; a Depression Suite including the GAD-7, and PHQ-9 assessments, a Depression & Suicide Risk Suite including the GAD-7, and CESD-R assessments; a Pain Suite including the ORT, PHQ-9, and PSEQ assessments; a Postpartum Suite including the CESD-R, EPDS, and GAD-7 assessments; a PTSD Suite including the CESD-R, GAD-7, and PCL-C assessments; a Substance Abuse Screening-Adult Suite including the ORT, AUDIT, PHQ-9, and GAD-7 assessments; and an Adult ADHD including the ASRS assessment.

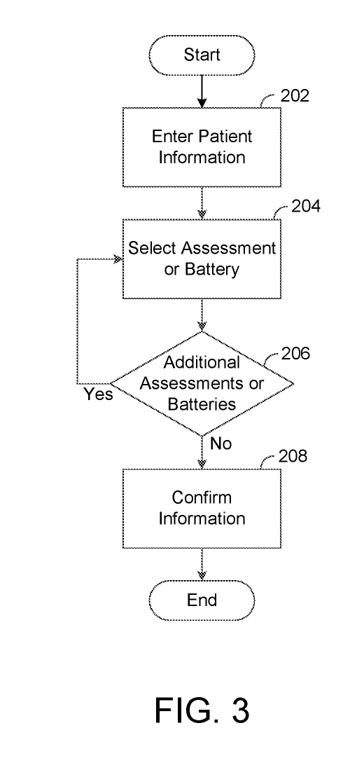

FIG. 3 shows an embodiment of a process for a healthcare provider 14 to select assessments for a patient 16. The operations depicted and described in FIG. 3 may be performed by the healthcare provider at either the provider portal 24 or in the mobile app 28. It will be understood that the steps of FIG. 3 are provided as exemplary steps, and that one or more steps may be removed or added, and that the order of steps may be modified.

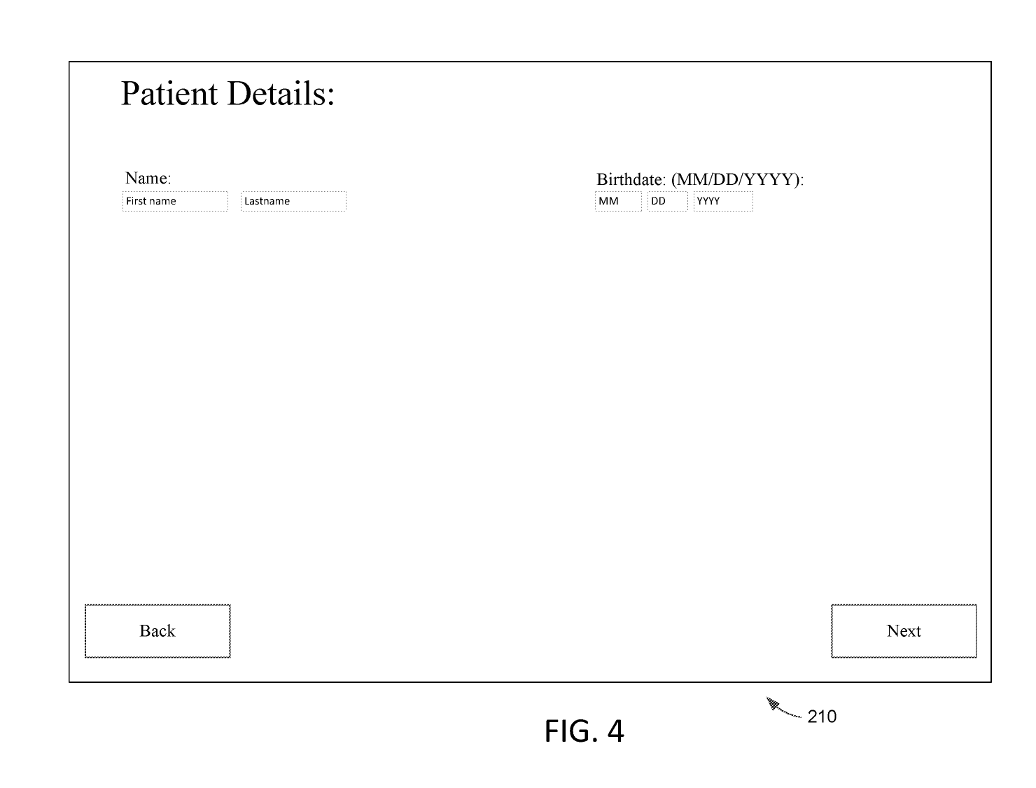

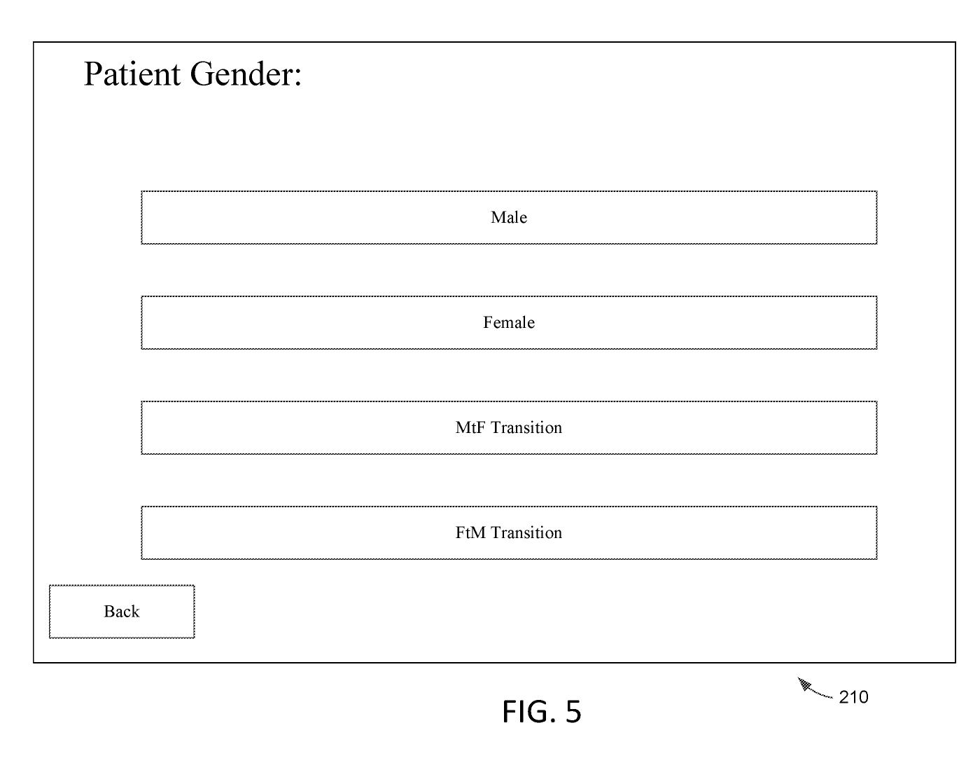

The process begins with the healthcare provider 14 selecting a patient 16 to complete one or more assessments and then entering information about the selected patient 16 into the provider portal 24 or the mobile app 28 (step 202). The provider portal 24 or the mobile app 28 can provide a user interface for the healthcare provider 14 with one or more screens or pages that enables the healthcare provider 14 to enter information about the selected patient 16. In one embodiment, FIGS. 4-9 show embodiments of pages or screens of a user interface 210 for a healthcare provider 14. In another embodiment, the healthcare provider 14 can provide appropriate authentication information (e.g., username and password, biometric information, etc.) before being provided access to the provider portal 24 or the mobile app 28. Once authenticated, the healthcare provider 14 can enter the selected patient's name and date-of-birth on a page of the user interface 210 (see FIG. 4) along with other information about the patient (e.g., the patient's gender) on other pages of the user interface 210 (see e.g., FIG. 5).

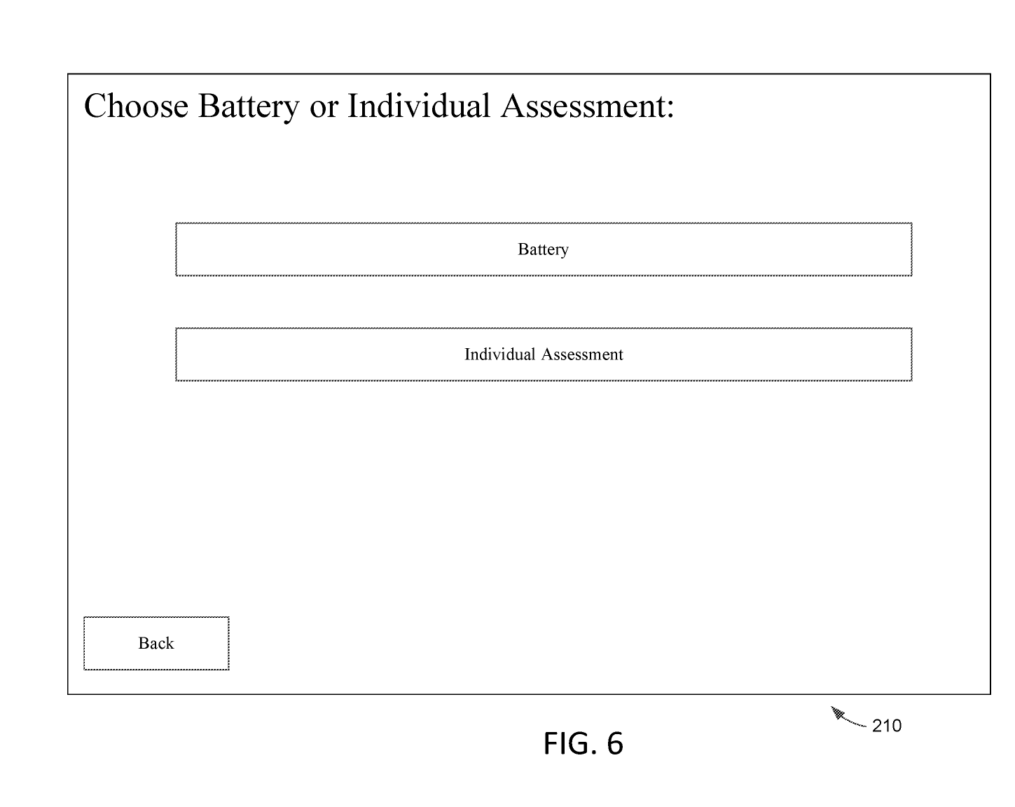

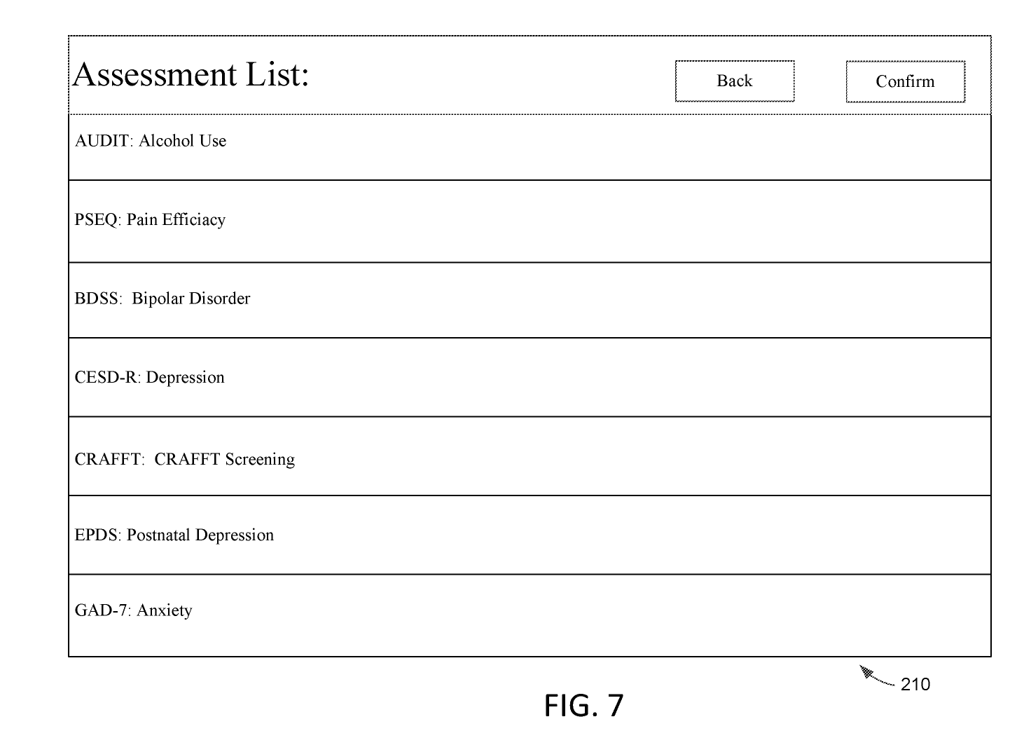

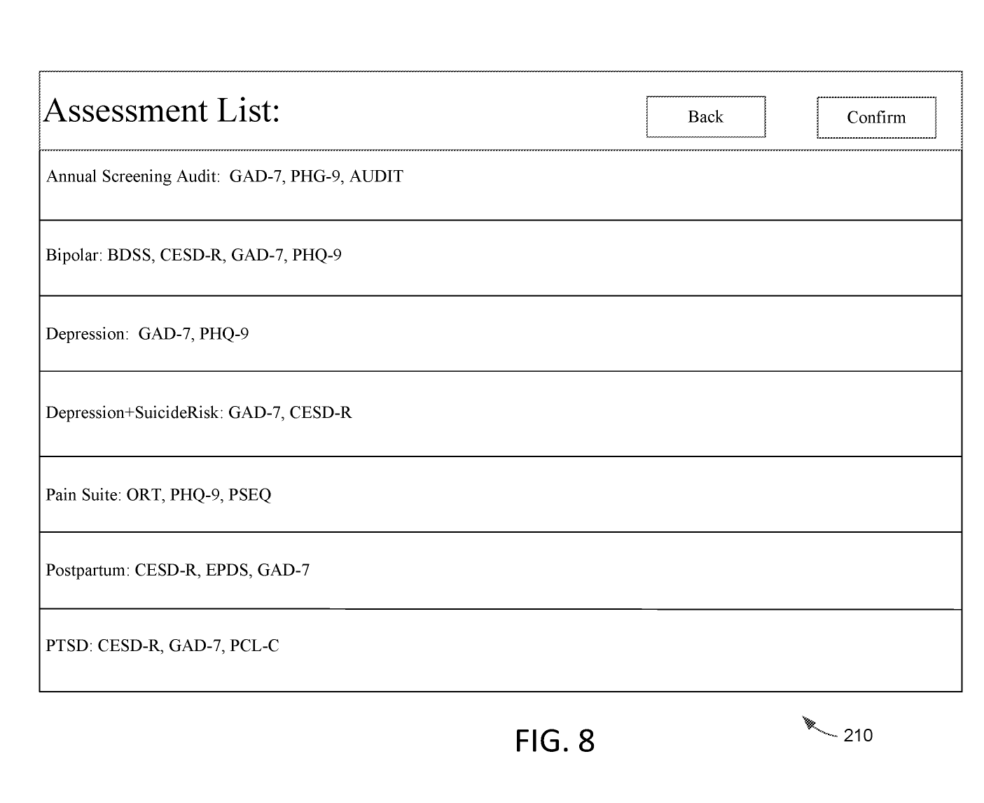

After entering the information on the selected patient 16, the healthcare provider 14 can then select the assessments and/or batteries that need to be completed by the selected patient 16 (step 204). The healthcare provider 14 can select between a listing of available assessments or a listing of available batteries on a page of the user interface 210 (see FIG. 6). Depending on the selection of the healthcare provider 14, a listing of assessments (see FIG. 7) or a listing on batteries (see FIG. 8) can be provided to the healthcare provider 14 at the user interface 210. The healthcare provider 14 can then select the desired assessments of batteries for the patient 16 from the listing of assessments or batteries at the user interface 210.

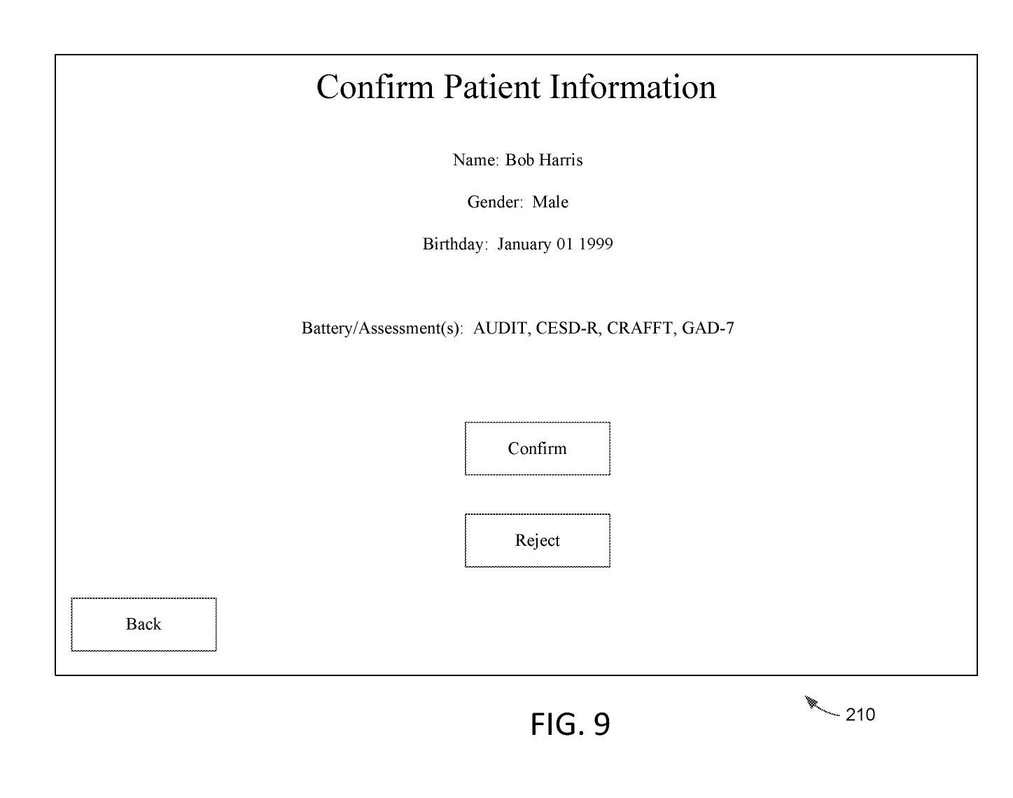

Upon the selection of one or more assessments or batteries, a determination is then made as to whether all of the assessments or batteries to be completed by the patient 16 have been selected (step 206). If all assessments or batteries to be completed by the patient 16 have not been selected the process returns to step 204 to permit the healthcare provider 14 to select additional assessments or batteries. If all the assessments or batteries needed by the patient 16 have been selected, then the healthcare provider 14 can confirm the information for the patient 16 (step 208) and the process ends. In making the decision to confirm the information and assessments for a patient 16, the healthcare provider 14 can review the information regarding the patient 16 and the selected assessments on a page of the user interface 210 (see FIG. 9). If the information regarding the patient 16 is correct, the healthcare provider 14 can confirm the information, otherwise the healthcare provider 14 can go back and repeat steps 202-206 to provide any incorrect or missing information for the selected patient 16.

Once the healthcare provider 14 has selected the assessments to be completed by the patient 16, the patient 16 can access the assessments via the patient portal 26 or the mobile app 28. When completing an assessment, the patient 16 can be presented, one screen or page at a time, with each question in the assessment. As the patient 16 advances or progresses through the assessment, the patient portal 26 or the mobile app 28 tracks the patient's progress and answers. In one embodiment, if the healthcare provider requests multiple assessments or chooses a battery (with several assessments), all questions can be chained together to present a seamless experience to the patient 16 of one continuous questionnaire. However, in other embodiments, each individual assessment can be provided to the patient 16 one at a time. Either the patient 16 can select the order of completion of the assessments or the healthcare provider 14 can designate the order in which the assessments are completed.

Each assessment can be answered through a simple, one-touch design interface provided by the patient portal 26 or the mobile app 28. Each type of question can have its own unique format and performance rules, which must be met before the user can advance to the next question in the assessment. In one embodiment, several question types with corresponding performance rules are described below.

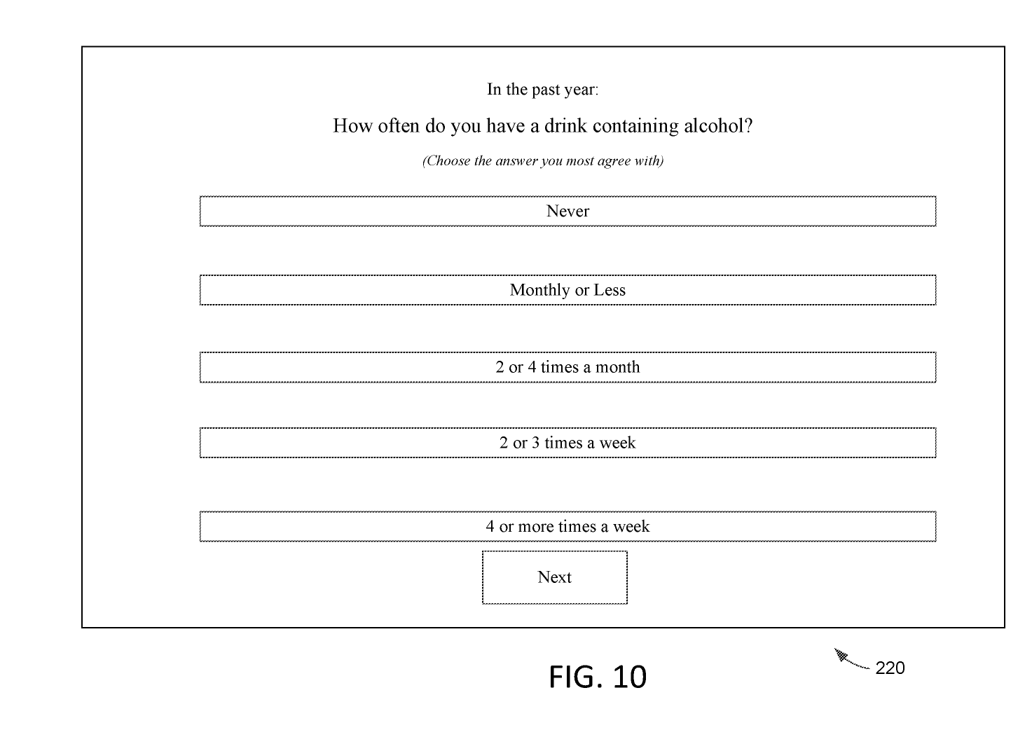

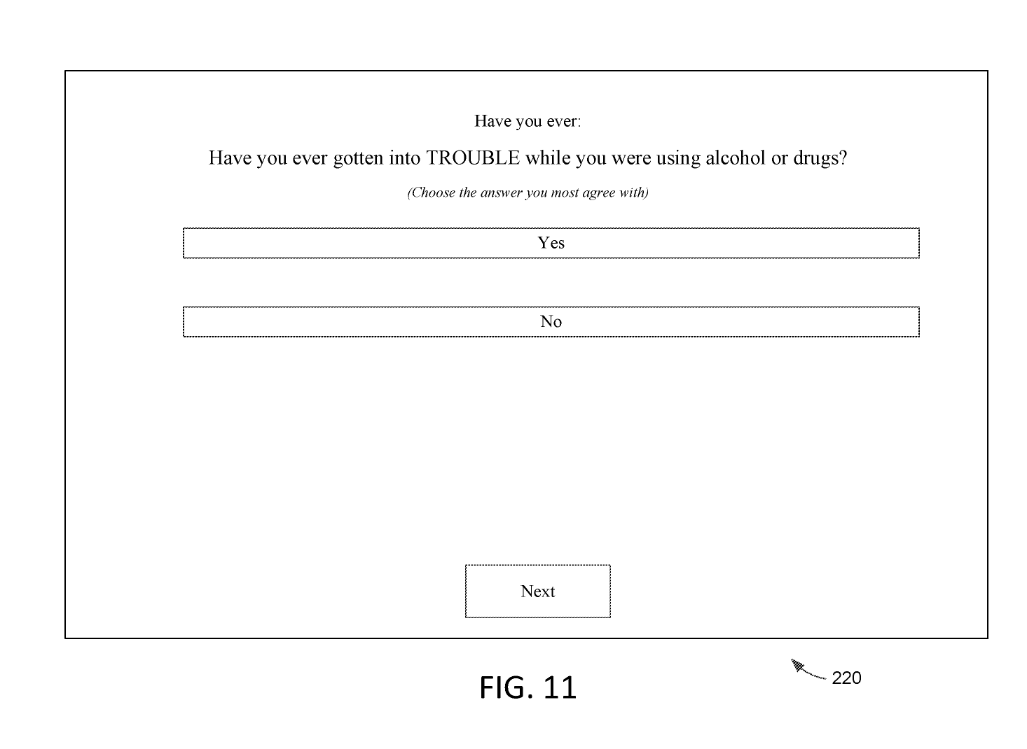

One question type can be a single answer question type. In a single answer question type, between 1-5 selectable buttons appear on the user interface or screen, each containing a possible answer. The question itself is listed above the buttons, with directions or answering qualifications (e.g., time frame, subjective perspective, etc.) listed below. Only one button may be selected at a time. If a new answer is selected, the previous answer is automatically unselected. Once an answer has been chosen, the patient is given the option to advance to the next question. In one embodiment, FIGS. 10 and 11 show embodiments of single answer question types on corresponding pages or screens of a patient interface 220.

Another question type can be a multi answer question type. In a multi answer question type, between 1-5 selectable buttons appear on the user interface or screen, each containing a possible answer. The question itself is listed above the buttons, with directions or answering qualifications (e.g., time frame, subjective perspective, etc.) listed below. Any number of buttons may be selected at a time. If a new answer is selected, the previous answer(s) can also remain selected. Clicking an already selected answer may be used to unselect the answer. The patient 16 does not need to select an answer before receiving the option to advance to the next question.

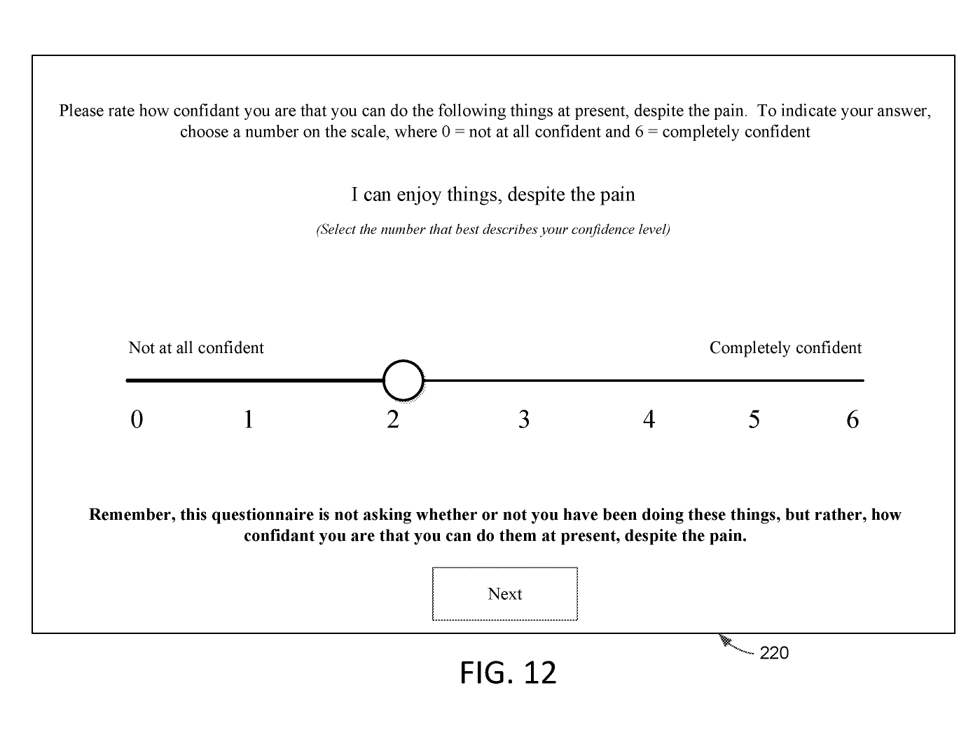

A further question type can be a sliding scale question type. In a sliding scale question type, a bar or line is positioned in the center of the user interface or screen, with a predetermined lower value (e.g., 0 or 1) and a predetermined upper value (e.g., 5, 7, or 11). Below the bar or line is a slider indicator of the currently selected answer. The question itself is listed above the buttons, with directions or answering qualifications (e.g., time frame, subjective perspective, etc.) listed below. A patient 16 can either click directly on a number on the line or drag the slider indicator to the correct numerical value of their answer. The patient 16 does not need to select an answer before receiving the option to advance to the next question, which can automatically assume the lowest possible value if none is selected. In one embodiment, FIG. 12 can show an embodiment of a sliding scale question type on a corresponding page or screen of a patient interface 220.

Upon completion of an assessment or battery, the patient's scores can be automatically calculated and transmitted by the patient portal 26 or mobile app 28 to the healthcare information platform 125 for storage in patient data 120. Each assessment can have a unique method of scoring, giving weight to certain answers or questions. Each of these scoring methods can strictly follow the specifications outlined in the assessment itself or as outlined by the corresponding governing body.

In one embodiment, to speed turnaround time and increase potential testing volume when using mobile app 28 in a clinic 22, a clinical technician can then be presented with an option to enter in a clinic pin code after completion of the assessment(s) by the patient 16 in order to begin processing the next patient 16. The use of the clinic pin code can ensure that only clinical users have access to the sign up and assessment selection portions of the mobile app 28 while minimizing the number of steps needed to process each patient 16.

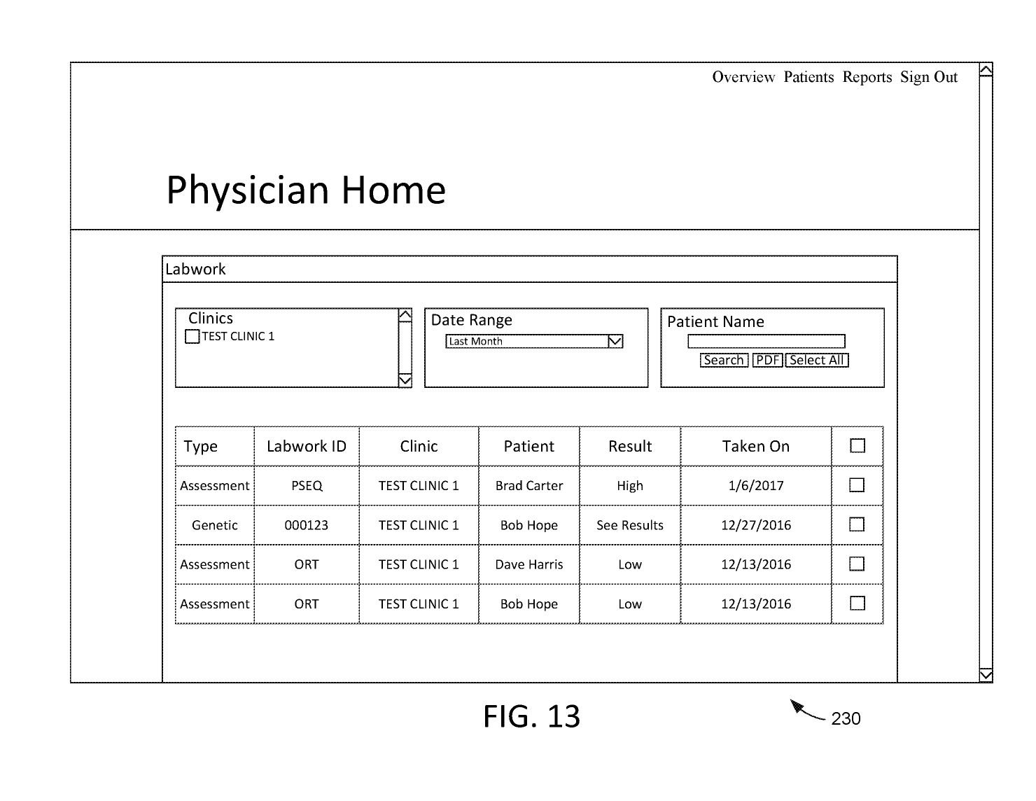

The provider portal 24 can operate as the primary access point for healthcare providers 14 into the healthcare information platform 125 and patient data 120. In one embodiment, FIGS. 13-17 show embodiments of pages or screens of a user interface from a provider portal 24. When a user accesses the provider portal 24, the “user role” is processed based on the authentication information provided by the user when accessing the provider portal 24. The provider portal 24 can then dynamically adjust the visual elements of the user interface provided by the provider portal 24 based on the user role. For example, EHR (electronic health record) printouts, patient chart upload, and patient portal sign up navigation items are hidden under the “physician role” to minimize the number of options for a physician and streamline the physician's access to patient information. Additionally, report filtering options can shift to include all clinics 22 the physician is associated with or related to within the system 10. In another example, when a “clinic user” (typically an office manager or receptionist) accesses the provider portal 24, the provider portal 24 can enable EHR print outs, patient chart upload, and patient portal sign up options and shift the report filtering options to include all physicians related to the current clinic of the clinic user.

In one embodiment, the design of the provider portal 24 can change when the provider portal 24 detects access from a mobile device (e.g., a smartphone or tablet). The reporting options on the “desktop version” of the provider portal 24 can download a PDF of the requested information to the user's computer. If the user accesses the provider portal 24 from a mobile device, the user can be presented with a PDF button to open the document in a new tab because document download can be an inefficient process on mobile devices. The operational difference between desktop versions and mobile versions of the patient portal 24 can be in addition to the ‘Responsive Design’ interface incorporated into the patient portal 24 that automatically adjusts widths and heights of on screen elements to accommodate the viewing platform.

The provider portal 24 can include a common filtering scheme across all reporting pages. All filter options can work in conjunction to pull only the most relevant search results. Test results and patient listings can be pared down using a variety of filtering options. For example, the results can be filtered based on a relation to the healthcare provider 14 (if logged in as a clinic user) or a relation to the clinic 22 where the test was performed (if logged in as a physician). The “relation” filter can have multiple values selected to display results from all, one, or many of the available options. The results may also be filtered on a date range when the test was performed or the patient's last visit. The “date” filter can be a single choice filter with values for today, this week, past 2 weeks, last month, 30 days, 60 days, 90 days, past year, or all time. In one embodiment, FIG. 13 can show an embodiment of date-filtered results on corresponding pages or screens of a physician interface 230. In addition, the results can be filtered with a text based filter keyed on the patient's name. The “text” filter can be a non-required free text field that automatically applies wildcard characters in the search logic to limit the number of entered characters.

As described above, patient charts and test results can be accessible in the provider portal 24 in a PDF format. In one embodiment, physicians and clinic users can pull a long-hand report (i.e., the complete report) of a patient's test results if the displayed “high-priority” items from the report do not provide enough information. The process of obtaining the complete report can be done for individual tests or, be done for multiple patients and/or tests through a batch download if the provider portal 24 has been accessed on the desktop. If the batch option is chosen, each patient's results can be saved under a separate folder with their identifying information and the group of folders is presented to the user as a single zip file with the current date. Additionally, clinic users have the option of uploading PDF copies of patient charts to the server 12 and patient data 120 to be used in auditing and billing processing.

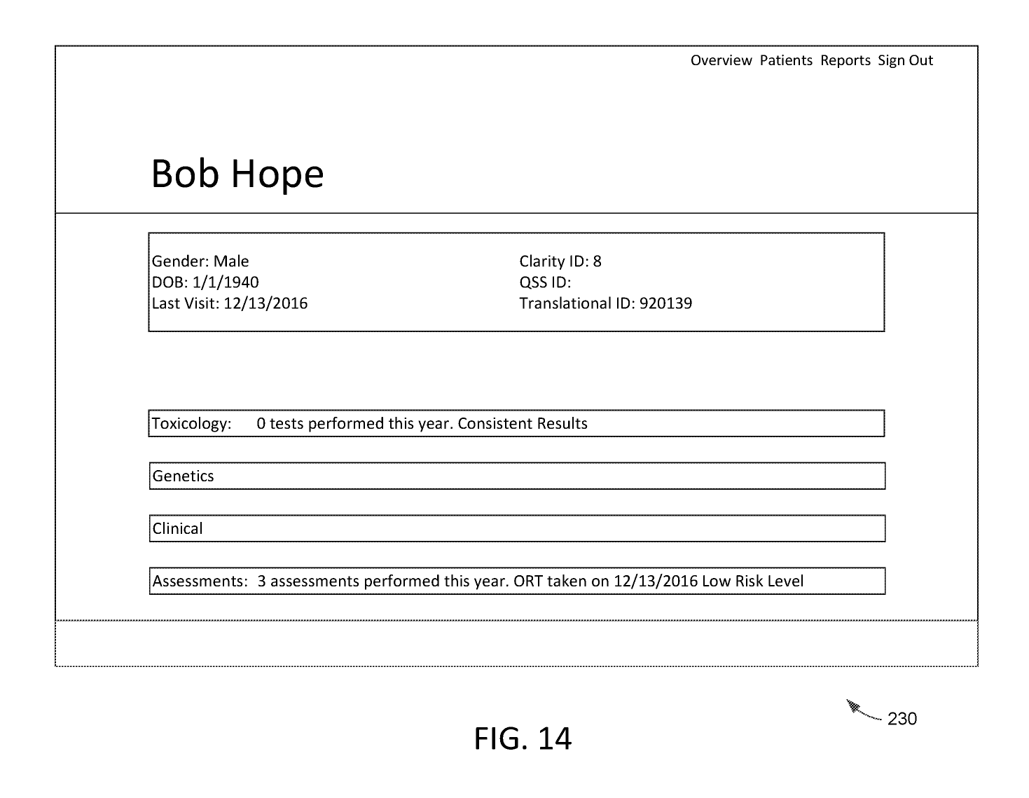

The patient detail area can be the central focus of the provider portal 24 and can be designed to give the healthcare provider 14 the maximum amount of information in the fewest possible steps. In one embodiment, the patient detail area can include a single screen or page with four collapsible sections, each section covering a different type of test result with corresponding summary information. The four sections can include toxicology results, clinical results, genetic results, and patient assessments. In one embodiment, FIG. 14 can show an embodiment of the patient detail area on corresponding pages or screens of a physician interface 230. While the patient detail area can have four sections in one embodiment, the patient detail area can have additional or fewer sections in other embodiments.

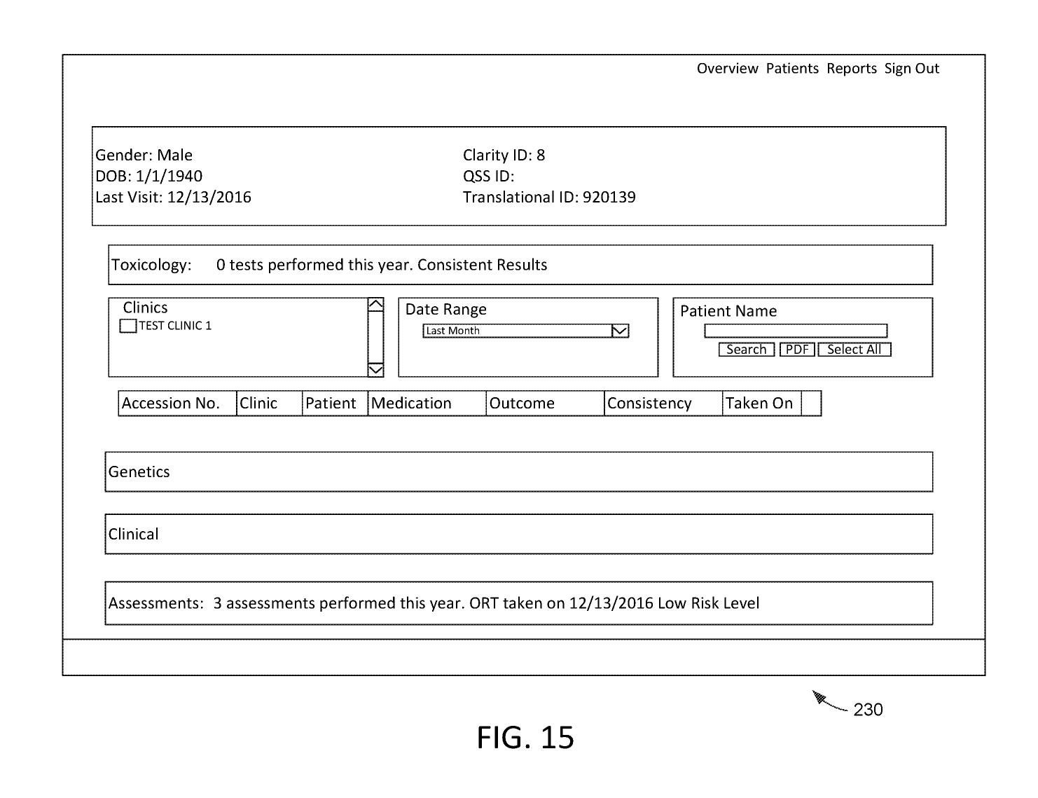

The toxicology results section can utilize a two-tone color scale (e.g., blue=no flagged issues, red=flagged issues/inconsistent results) based on the most recent test results. The summary header for the toxicology results section can show the number of tests taken year to date and the summary results of the most recent test. The toxicology results section can be expanded to list all individual flagged lines from any toxicology results logged under the patient, which can be further filtered, as described above, to gather patient history. In one embodiment, FIG. 15 can show an embodiment of a patient detail area with an expanded toxicology section on corresponding pages or screens of a physician interface 230.

The clinical results section can utilize a two-tone color scale (e.g., blue=normal results, red=abnormal results) based on the most recent test results. The summary header for the clinical results section can show the number of tests taken year to date and the summary result of the most recent test. The clinical results section can be expanded to list all individual abnormal lines from any clinical results logged under the patient 16, which can be further filtered, as described above, to gather patient history.

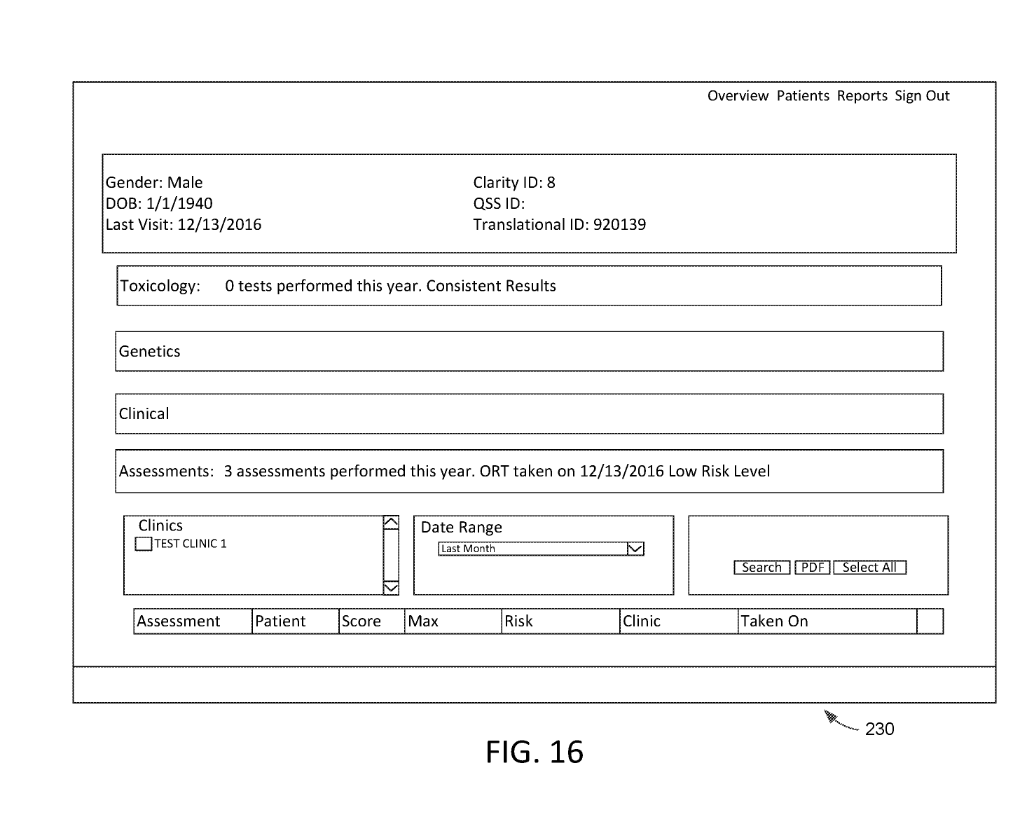

The patient assessments section can utilize a three-tone color scale (e.g., blue=no/low risk, orange=moderate risk, red=high risk) based on the patient's most recent mental assessment or battery results. The patient assessment section can be expanded to list all individual assessment results from any assessments logged under the patient 16, which can be further filtered, as described above, to gather patient history. In one embodiment, FIG. 16 can show an embodiment of a patient detail area with an expanded assessments section on corresponding pages or screens of a physician interface 230.

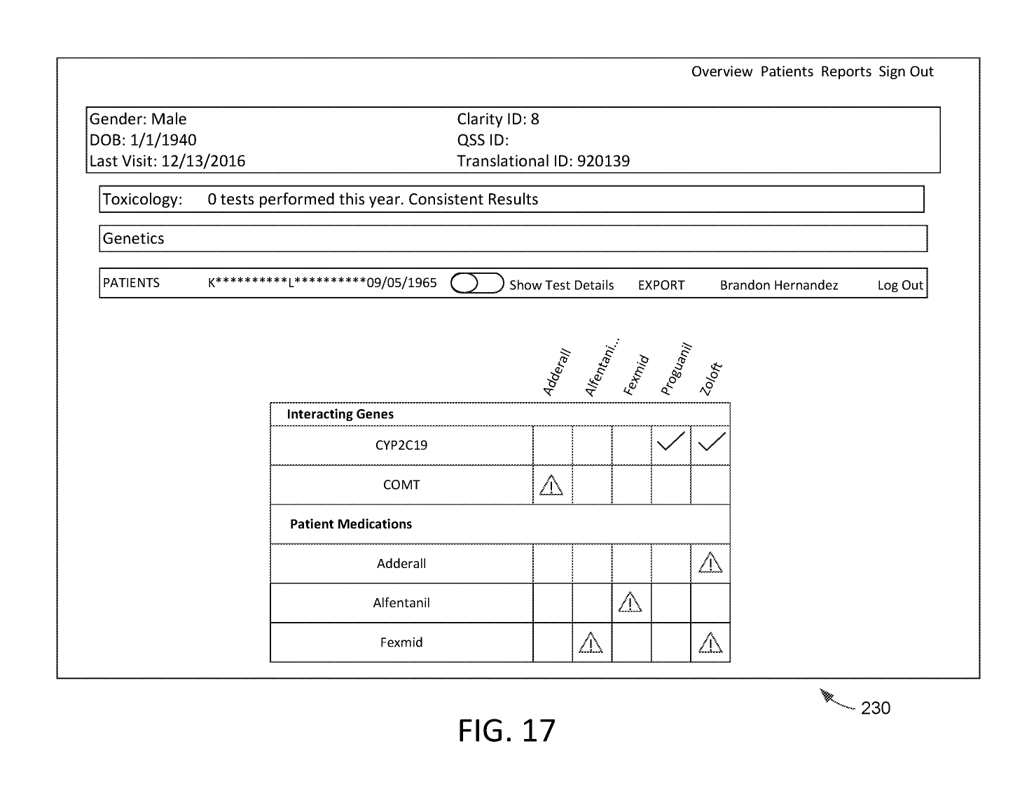

The genetic results section can utilize a three-tone color scale (e.g., blue=no risk, orange=moderate risk, red=high risk) based on the patient's listed medication's, drug-to-drug interactions and how the patient's medications interact with the patient's genetic profile. In one embodiment, FIG. 17 can show an embodiment of a patient detail area with an expanded genetics section on corresponding pages or screens of a physician interface 230. The genetic results section can be expanded to view and interact with a “Gen4Life” tool. The Gen4Life tool can be an interactive tool embedded in the provider portal 24. The Gen4Life tool interfaces with an external reporting system to provide details about a patient's genetic profile and how the patient's genetic profile interacts with the patient's current list of medications. Additionally, the Gen4Life tool automatically checks for contrapositive drug-to-drug interactions with the listed medications. The Gen4Life tool can include a color-coded iconography (e.g., green check=good result, orange triangle exclamation=warning or moderate conflict, red round exclamation=high risk or dangerous conflict) to easily identify problem interactions. Patient medications can be added or removed through the Gen4Life tool which automatically triggers the drug-to-gene and drug-to-drug interactions to be refreshed.

In one embodiment, clinic users have access to a screen enabling them to sign up patients 16 for one-time access to the patient portal 26. Required information can include the patient's first and last name, the patient's date of birth, a valid email address, the patient's primary healthcare provider, and which assessment and/or battery they are required to complete. In one embodiment, the “sign-up” screen can list 10 rows at a time to enable several patients to be enrolled with a single click. However, more or less than 10 rows can be used in other embodiments. If the patient 16 needs to take multiple assessments or batteries, the patient can have their information copied to the next row with a single button. Once all patient information is entered, the clinic user can send out invitation emails to all listed patients 16 with a single button press.

In one embodiment, the patient portal 26 permits patients 16, that either do not have access to the mobile app 28 or are required to complete their assessments ahead of their clinic appointment, to take pre-selected (by the physician), self-administered assessments and/or batteries. A patient 16 having to use the patient portal 26 to complete assessments and/or batteries can receive an automatic email after being signed up by a clinic user in the provider portal 24. The email can include a website address and a temporary password, which is good for 60 days, in order to access the patient portal 26. After either 60 days or the assessment is completed, the password will be marked inactive and cannot be used again. The patient 16 provides predefined information (e.g., full name, date of birth, and/or the temporary password) to gain access to the patient portal 26. Once authenticated, the patient is presented with a brief overview of what is expected of the patient, what the assessment can entail, and how to proceed. To ensure correct scoring, the patient 16 can select their gender before taking the assessment(s).

Assessments or batteries can be pre-selected for the patient 16 when the patient 16 is signed up to receive the patient portal 26. One or more assessments and/or batteries (and the component assessments of those batteries) can be automatically concatenated to provide one seamless questionnaire for the patient 16 in the patient portal 26. Each component assessment question is taken on a single page which must be completed before advancing to the next page. Each assessment page can include only a reference to the corresponding assessment or battery, with no other identifying information included that might skew a patient's answering. Each question can be listed in order, with a simpler model than the mobile app 28. Multi-answer questions can be represented by a series of check boxes and both Single Answer and Sliding Scale questions can be represented with single-choice drop down boxes. When all component assessments and/or batteries have been completed, the patient 16 is given a chance to confirm that all answers are correct and accurate before the results are submitted. Once submitted, the assessments and batteries can be scored per the same logic as in the mobile app 28 and the patient's temporary password is disabled.

In one embodiment, the therapy logic 128 of the healthcare information platform 125 can be used to assist healthcare providers 14 in the implementation of therapies for patients 16. The therapy logic 128 can incorporate one or more sets of policies and procedures that adhere closely with state and federal regulatory agency guidelines for each of the therapies supported by the therapy logic 128. The therapy logic 128 can be used by healthcare providers 14 to help verify patient 16 suitability for a particular therapy, train the healthcare providers 14 on how to identify and manage patients 16 at high risk for abusing or diverting controlled substances and to reduce the likelihood of prescription drug abuse and diversion.

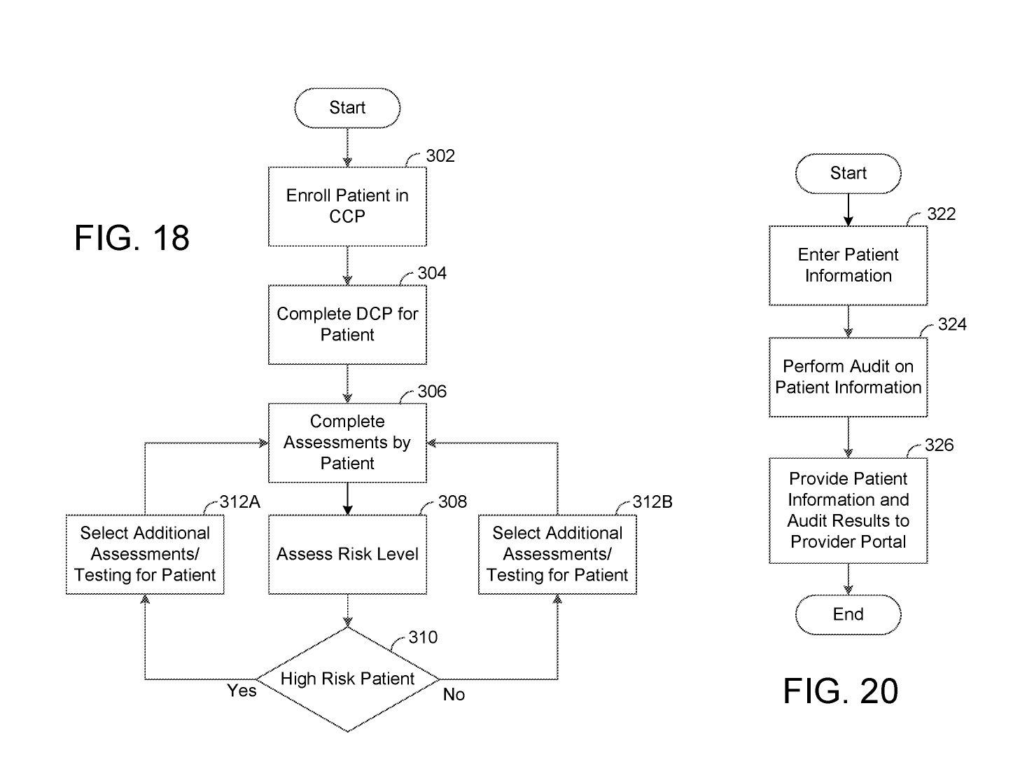

FIG. 18 shows an embodiment of a process for initiating a care continuity program for a patient undergoing a preselected therapy using the therapy logic 128. The operations depicted and described in FIG. 18 may be completed by the healthcare provider 14 and/or the patient 16 using the provider portal 24, the patient portal 26 or the mobile app 28. It will be understood that the steps of FIG. 18 are provided as exemplary steps, and that one or more steps may be removed or added, and that the order of steps may be modified. The process of FIG. 18 will described in the context of initiating a care continuity program (CCP) for a patient undergoing chronic opioid therapy, but it will be understood that the process can apply to initiating a CCP for any type of therapy.

The process begins with enrolling the patient 16 in a CCP (step 302). As part of the process for enrolling a patient in the CCP, clinic staff can be educated on patient-tailored opioid policies by the therapy logic 128. Also, each patient 16 receiving opioid prescriptions for chronic pain is required to sign a form indicating their understanding and agreement to be enrolled in the CCP and to disclose HIPAA (Health Insurance Portability and Accountability Act) information to healthcare providers 14. Next a diversion control plan (DCP) can be completed for the patient 16 (step 304). The therapy logic 128 can assist in creating and fully implementing the DCP for therapies, such as chronic opioid therapy, that prescribe controlled substances to reduce the likelihood of prescription drug abuse and diversion by the patient 16. The DCP can be important because without a DCP there is an increased risk for civil and criminal liability to the healthcare providers 14.

In addition, when completing a DCP for a patient, the clinic 22 can be required to complete an “office acknowledgement” form indicating that the clinic 22 and healthcare providers 14 are implementing the suggested safety measures in accordance with the “Common Elements in Guidelines for Prescribing Opioids for Chronic Pain” set forth by the CDC (Center for Disease Control) in all good faith. For example, some of the “office acknowledgement” safety measures can include: conducting a physical exam, pain history, past medical history, and family/social history; conducting urine drug testing (UDT), when appropriate (including baseline and random testing); considering all treatment options, weighing benefits and risks of opioid therapy, and using opioids when alternative treatments are ineffective; starting patients on the lowest effective dose; implementing pain treatment agreements; initiating pain treatment agreements; monitoring pain and treatment progress with documentation, using greater vigilance at higher doses; and using safe and effective methods for discontinuing opioids (e.g., tapering, making appropriate referrals to medication-assisted treatment, substance use specialists, or other services).

The completion of the DCP can include healthcare providers 14 and/or clinic staff being trained on aberrant medication-taking behavior. For example, some of the aberrant medication-taking behaviors can be organized into the following groups: common red flags; handling aberrant behavior for possible addiction; and handling aberrant behavior for lack of benefit. The behaviors of the patient 14 associated with common red flags can include: deterioration in functioning at work or socially; illegal activities—selling, forging, buying from nonmedical sources; injection or snorting medication; multiple episodes of “lost” or “stolen” scripts; resistance to change therapy despite adverse effects; refusal to comply with random drug screens; concurrent misuse of alcohol or illicit drugs; use of multiple physicians and pharmacies; requesting controlled substances by name; health care use patterns (e.g., inconsistent appointment patterns); signs/symptoms of drug misuse (e.g., intoxication); emotional problems/psychiatric issues; lying; and problematic medication behavior (e.g., noncompliance).

The behaviors of the healthcare provider 14 for handling aberrant behavior for possible addiction can include: take a non-judgmental stance; use open-ended questions; state your concerns about the behavior; examine the patient for signs of flexibility; place more focus on specific opioid or pain relief; approach as if they have a relative contraindication to controlled drugs (if not absolute contraindication); explain why aberrant behavior raises your concern for possible addiction; explain that benefits no longer outweigh risks; state “I cannot responsibly continue prescribing opioids as I feel it would cause you more harm than good; always offer referral to addiction treatment; and stay 100% in “Benefit/Risk of Medication” mindset. The behaviors of the healthcare provider 14 for handling aberrant behavior for lack of benefit can include: stress how much you believe in/empathize with patient's pain severity and impact; express frustration (e.g., lack of good pill to fix problem); focus on patient's strengths; encourage therapies for “coping with” pain; show commitment to continue caring about patient and pain, even without opioid prescriptions; and schedule close follow-ups during and after tapering

The completion of the DCP can include healthcare providers 14 and/or clinic staff being trained on the current recommendations and best practices for UDT (Urine Drug Testing) including methodology, scheduling, and suggested corrective action and being trained on how to properly calculate patient daily MED (Morphine Equivalent Dosage). The physician is instructed to calculate the dosage for any opioid prescription and to begin the prescription at the lowest effective dose. Special attention can be provided for any patient with a MED greater than 50 mg/day. Further, a MED of 90 mg/day (or higher) should be avoided outright or prescribed only under extreme conditions.

The completion of the DCP can also include healthcare providers 14 and/or clinic staff being trained on how to access and utilize the corresponding statewide PDMP (Prescription Drug Monitoring Program) database to combat “prescription shopping” and identify drug abuse and diversion and being trained on the various safe opioid tapering methods. For example, some of the safe opioid tapering methods can be organized into the following groups: detoxification settings; duration of tapering, agents used to taper; regimes to adjusting tapering schedules and methods; and adjunctive therapy and advising patient on withdrawal signs and symptoms. The safe opioid tapering methods associated with detoxification settings can include: ultra-rapid detoxification; inpatient detoxification; and outpatient detoxification. The safe opioid tapering methods associated with duration of tapering can be organized into the following groups: Katrina disaster working group suggested tapering; VA (Veterans Administration) suggested tapering for short-acting opioids; and VA suggested tapering for long-acting agents. The duration of tapering methods associated with Katrina disaster working group suggested tapering can include: reduction of daily dose by 10% each day; reduction of daily dose by 20% every 3-5 days; or reduction of daily dose by 25% each week. The duration of tapering methods associated with VA suggested tapering for short-acting opioids can include: decrease dose by 10% every 3-7 days; or decrease dose by 20-50% per day until lowest available dosage form is reached, then increasing the dosing interval, eliminating one dose every 2-5 days. The duration of tapering methods associated with VA suggested tapering for long-acting agents can include: methadone—decrease dose by 20-50% per day to 30 mg/day, then decrease by 5 mg/day every 3-5 days to 10 mg/day, then decrease by 2.5 mg/day every 3-5 days; morphine controlled-release—decrease dose by 20-50% per day to 45 mg/day, then decrease by 15 mg/day every 2-5 days; oxycodone controlled-release—decrease by 20-50% per day to 30 mg/day, then decrease by 10 mg/day every 2-5 days; or fentanyl—first, rotate to another opioid, such as morphine CR or methadone, then follow guidelines, as above. The withdrawal signs and symptoms associated with adjunctive therapy and advising patient on withdrawal signs and symptoms can include: abdominal cramps; anxiety; diaphoresis; diarrhea; dilated pupils; goose bumps; hypertension; insomnia; lacrimation; muscle twitching; rhinorrhea; tachycardia and tachypnea.

Referring back to the process of FIG. 18, the patient 16 can then complete the assessments (step 306) selected during the preparation of the CCP and/or the DCP. For example, opioid prescription patients enrolled in a CCP are screened for addiction to or non-medical use of prescribed and un-prescribed medication. In addition, the patient's pain level, functionality, and side-effects of opioid prescription can also be assessed. After the patient completes the assessments, a patient risk level is scored and assessed (step 308) using the healthcare information platform 125 and/or the therapy logic 128 which dictates UDT and mental assessment testing schedules. Next, a determination is made as to whether the patient 16 is a high risk patient (step 310).

If the patient is a high risk patient, additional assessments and/or testing are selected for the patient 16 (step 312A). For example, high risk patients can be enrolled in yearly testing for the ORT, SOAPP-R, and PCLC (only if the patient is a veteran or a previous/current first responder) assessments. The high risk patient is also subject to the COMM assessment once every three months, a monthly diagnostic assessment to detect pain levels and functionality, a monthly PHQ-9 assessment (if the patient shows signs of depression), and a monthly UDT.

If the patient is not a high risk patient (i.e., a low risk patient), additional assessments and/or testing are selected for the patient 16 (step 312B). For example, a low risk patient can be enrolled in yearly testing for the ORT, SOAPP-R, and PCLC (only if the patient is a veteran or a previous/current first responder) assessments. The low risk patient is also subject to the COMM assessment, diagnostic assessment to detect pain levels, PHQ-9 assessment (if they show signs of depression), and UDT once every three months.

In one embodiment, clinic users signing up patients 16 to take assessments on the patient portal 26 have an additional option for the CCP battery, which automatically enrolls the patient into a CCP. In other words, step 302 of the process of FIG. 18 can be automatically completed by the healthcare information platform 125 upon completion of the CCP battery by the patient 16. The automatic enrollment of a patient in a CCP can trigger several automatic processes. For example, some of the automatic processes can include: creating a rolling, 12-month testing schedule, which automatically tracks the progress of the patient within the testing cycle for which assessments have been completed and which assessments are upcoming; automatically sending email notifications and passwords to the patient 16 for accessing the patient portal 26 and reminding the patient 16 when tests are upcoming and shortly after they are overdue; and tracking missed assessments in a “Results” section of the patient detail area of the provider portal 24.

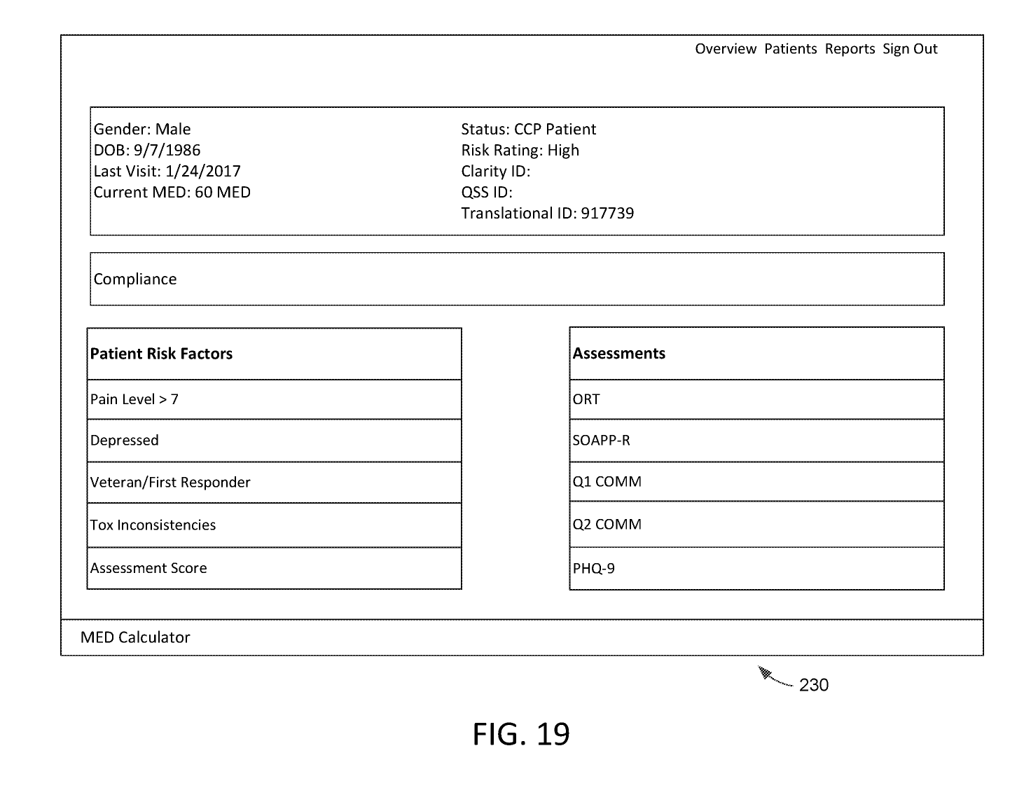

In one embodiment, the results section in the patient detail area in the provider portal 24 can be a collapsible section alongside the existing toxicology, clinical, genetic, and mental assessment sections. In one embodiment, FIG. 19 can show an embodiment of a patient detail area with an expanded results section on corresponding pages or screens of a physician interface 230. The results section can be used to track all completed assessments in the current 12-month test cycle and list high risk answers or scores alongside an overall CCP score for the patient to give the physician a snapshot of the patient's status. For example, high risk answers and/or scores can include: pain level greater than 7 out of 10; depression; veteran or first responder; inconsistencies in UDT results; a “High Risk” score on ORT, SOAPP-R, COMM, PHQ-9, or PCLC assessments; or missing one or more scheduled CCP assessments. The Results section can also chart CCP scheduled assessments that have been missed to give the physician better visibility into the patient's pattern of aberrant behavior and includes a collapsible sub-section containing an MED calculator. The patient's current medication, dosage, and number of pills can be entered into the MED calculator so the physician can easily determine the patient's current MED or determine the lowest effective dosage of a new prescription.

In another embodiment, DCP documents can be available for viewing in the provider portal 24 through a compliance navigation tab. Documents can be updated from the healthcare information platform 125 as new procedures are developed to ensure all enrolled clinics have uniform access to the latest documentation. For example, the documents under the compliance navigation tab can include: risks and recommendations, healthy treatment protocols, treatment plan evaluation and documentation plan.

The healthcare information platform 125 can also provide an auditing capability to healthcare providers 14. Audit results can be available for viewing by physician users in an audit results navigation tab in the provider portal 24. In one embodiment, the audits can be downloaded as a PDF for submission to governing bodies as needed. An auditor security role can be provided that is focused on performing online auditing for enrolled clinics 22. The auditor security role can have access to create new audits, view archived audits, as well and viewing and updating DCP documents shared between enrolled clinics.

In one embodiment, online audit capturing is available to audit users. The layout of the audit section can follow the same collapsing section design used for the other sections of the patient detail area of the provider portal 24. The auditor, when accessing the audit section, has an initial choice between an initial visit audit and a follow-up visit audit. Once the type of audit is selected, the healthcare information platform 125 can dynamically load the appropriate sections/questions for the selected audit. For example, the initial visit audit questions can relate to: patient demographics; initial assessment; treatment goals; and treatment plan. In another example, the follow-up visit audit questions can relate to: patient demographics; follow-up visits; and treatment plan updates. Each audit question can include a drop-down box to record a fixed answer and an associated free text field for comments and notes. Upon submission, each question is automatically scored on a predetermined scale (e.g., 0 to 2), then averaged to achieve a compliance score out of 100 for the physician and clinic. The results, including the scores, can be distributed to the healthcare providers 14 and archived with the date, related physician, related clinic, and auditor for later PDF download, as needed to provide the audit information to the Department of Health, medical examiners, or other regulatory organizations.

FIG. 20 shows an embodiment of a process for performing an audit on patient information. The healthcare information platform 125 can be used to facilitate the operations depicted and described in FIG. 20. It will be understood that the steps of FIG. 20 are provided as exemplary steps, and that one or more steps may be removed or added, and that the order of steps may be modified.

The process begins with providing patient information (e.g., a patient chart) to the healthcare information platform 125 (step 322). Once the patient information has been provided to the healthcare information platform 125, an auditor can perform an audit of the patient information (step 324). In one embodiment, audits can be performed on a predetermined time period (e.g., monthly) by a specially trained auditor. As described above, the audit can analyze both the health information or chart from an initial visit of a patient or target a previously audited patient chart or health information for a follow up audit. When the audit is complete, the healthcare information platform 125 can provide the patient information and the audit results to the provider portal 24 (step 326) for access by the healthcare providers 14. In one embodiment, the audit results can be used to compile a report that determines the healthcare provider's compliance rating.

In one embodiment, the audit can assess if the clinic is correctly following healthy treatment protocols by asking a series of questions broken down into distinct categories depending on whether the audit is an initial audit or a follow-up audit. The healthy treatment protocols can include categories related to: diagnosis; treatment goals; treatment plans; documentation and follow-up assessments. Further, several categories may be organized into sub-categories to better organize the corresponding questions.

The diagnosis category can be organized into the following sub-categories: initial visit; existing risk factors; and past or present medications. The initial visit sub-category can include questions related to: the physical exam; the pain assessed; the onset and duration of pain (e.g., acute, subacute, or chronic); the function assessed; the diagnostic, therapeutic, and laboratory results; and the patient history. The existing risk factors sub-category can include questions related to: a relative risk assessment (e.g., ORT, SOAPP-R, or COMM); a history of, or current, depression; a determination of previously, or currently, a veteran or first responder; and a history of, or current, substance misuse (e.g., PDMP, UDT, or aberrant behavior). The past or present medications sub-category can include questions related to: a concomitant benzodiazepine/opioid therapy; a morphine equivalent dose>50 (primary care); and a morphine equivalent dose>90 (pain specialty).

The treatment goals category can include questions related to: activities of daily living; pain reduction as a secondary goal; a risk mitigation plan; counseling patient on risks of opioids; and setting reasonable expectations for treatment. The treatment plan diagnosis category can be organized into the following sub-categories: plan specifics; and risk/benefit consideration. The plan specifics sub-category can include questions related to: reflecting treatment goals; clearly setting expectations, including risks to patient; and further investigating, if pathophysiology is not understood. The risk/benefit consideration sub-category can include questions related to: if patient is a high risk for abuse, opioid therapy should not be an option; if patient is a low risk for abuse, and opioid therapy is a beneficial option, patient should be started on lowest dose (after considering morphine equivalence and long acting vs. short acting formulations); and alternative treatments should be considered and used where possible, before initiating controlled substance therapy.

The documentation category can include questions related to: the use of an opioid specific template; clearly explaining rational for initiating, continuing, tapering, or discontinuing opioid therapy; considering risk vs. benefit; clearly citing patient explanation for any aberrant substance taking behavior; and clearly citing treatment plan modifications due to aberrant substance taking behavior. The follow-up assessment category can be organized into the following sub-categories: review treatment goals; and use the “5 A's of pain.” The review treatment goals sub-category can include questions related to: effectiveness of therapy in achieving function and pain goals; side effects; activities of daily living (psychosocial functioning); and aberrant medication-taking behavior. The use the “5 A's of pain” sub-category can include questions related to: analgesia; activities of daily living; adverse events; aberrant substance taking behavior; and affect.

Embodiments within the scope of the present application include program products with machine-readable media for carrying or having machine-executable instructions or data structures stored thereon. Machine-readable media can be any available non-transitory media that can be accessed by a general purpose or special purpose computer or other machine with a processor. By way of example, machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communication connection (either hardwired, wireless, or a combination of hardwired or wireless) to a machine, the machine properly views the connection as a machine-readable medium. Combinations of the above are also included within the scope of machine-readable media. Machine-executable instructions include, for example, instructions and data which cause a general purpose computer, special purpose computer, or special purpose processing machine to perform a certain function or group of functions. Software implementations could be accomplished with standard programming techniques, with rule based logic and other logic to accomplish the various connection steps, processing steps, comparison steps and decision steps.

It should be understood that the identified embodiments are offered by way of example only. Other substitutions, modifications, changes and omissions may be made in the design, operating conditions and arrangement of the embodiments without departing from the scope of the present application. Accordingly, the present application is not limited to a particular embodiment, but extends to various modifications that nevertheless fall within the scope of the application. It should also be understood that the phraseology and terminology employed herein is for the purpose of description only and should not be regarded as limiting.

What is claimed is:

1. A healthcare information system comprising:
a first computing device;
a second computing device;
a third computing device, the third computing device configured to provide a report with first healthcare information associated with a patient;
a server computer coupled to the first computing device, the second computing device and the third computing device by a network, the server computer comprising:
a processor;
a memory coupled to the processor, wherein the memory is configured to store a plurality of processing instructions, the plurality of processing instructions cause the processor to:
create a record to store data associated with the patient, wherein the record has a predetermined format;
receive the report with first healthcare information from the third computing device via a secure process;
receive second healthcare information associated with the patient from at least one of the first computing device or the second computing device;
convert each of the first healthcare information and the second healthcare information into the predetermined format;
store the converted first healthcare information and the converted second healthcare information in the record;
cross-reference the converted first healthcare information and the converted second healthcare information; and
provide the cross-referenced healthcare information to at least one of the first computing device or the second computing device.

2. The healthcare information system of claim 1, wherein the received second healthcare information corresponds to at least one patient assessment completed by the patient.

3. The healthcare information system of claim 2, wherein the plurality of processing instructions cause the processor to permit a healthcare provider to select the at least one patient assessment for the patient from a list of patient assessments.

4. The healthcare information system of claim 1, wherein the first healthcare information includes genetic information associated with the patient and at least one of a toxicology report or a blood test result associated with the patient.

5. The healthcare information system of claim 4, wherein the received second healthcare information includes a medication list for the patient and the plurality of processing instructions cause the processor to calculate a risk level for the patient based on the first healthcare information and the second healthcare information.

6. The healthcare information system of claim 1, wherein the first computing device is configured to provide a first interface, and wherein the first interface is a provider portal accessible by a healthcare provider, the provider portal configured to display the cross-referenced healthcare information to the healthcare provider.

7. The healthcare information system of claim 1, wherein the plurality of processing instructions cause the processor to:
create a plurality of records to store data associated with a plurality of patients;
store healthcare information regarding the plurality of patients in corresponding records of the plurality of records; and
perform a demographic analysis on the stored healthcare information in the plurality of records.

8. The healthcare information system of claim 1, wherein the plurality of processing instructions cause the processor to provide an audit interface to a user to permit the user to perform an audit on the converted first healthcare information and the converted second healthcare information stored in the record.

9. The healthcare information system of claim 1, wherein the plurality of processing instructions cause the processor to provide an application programming interface to manage data transfer between the server computer and the first computing device, the second computing device and the third computing device.

10. The healthcare information system of claim 9, wherein the first computing device and the second computing device share a reference to the application programming interface and the application programming interface is configured to control access to the server computer by the first computing device and the second computing device.

11. A method for evaluating patient risk comprising:
receiving first healthcare information associated with a patient from a first source, wherein the first healthcare information includes at least one of a toxicology report, a blood test result or a medication list associated with the patient;
normalizing the first healthcare information into a predetermined format and storing the normalized first healthcare information;
receiving second healthcare information associated with the patient from a second source, wherein the second healthcare information includes genetic information associated with the patient;
normalizing the second healthcare information into the predetermined format and storing the normalized second healthcare information with the normalized first healthcare information;
automatically processing the normalized first healthcare information and the normalized second healthcare information to determine a patient risk level after the storing of the normalized second healthcare information;
providing the patient risk level to a healthcare provider with at least a portion of at least one of the first normalized healthcare information or the second normalized healthcare information;
receiving third healthcare information associated with the patient from a third source, wherein the third healthcare information includes at least one of a toxicology report, a blood test result or a patient medication list and is different from the first healthcare information;
normalizing the third healthcare information into the predetermined format and storing the normalized third healthcare information with the normalized second healthcare information and the normalized first healthcare information;
automatically updating the patient risk level after the storing of the normalized third healthcare information; and
providing the updated patient risk level to the healthcare provider.

12. The method of claim 11, further comprising adjusting at least one of a drug policy or treatment plan for the patient after the updated patient risk level.

13. The method of claim 11, further comprising cross-referencing the normalized first healthcare information, the normalized second healthcare information and the normalized third healthcare information.

14. The method of claim 11, wherein the normalizing the first healthcare information, normalizing the second healthcare information and normalizing the third healthcare information each includes parsing the corresponding healthcare information into segments and one of storing the parsed segments in an existing record for the patient or creating a new record for the patient and storing the parsed segments in the new record.

15. The method of claim 11, wherein the receiving first healthcare information, receiving second healthcare information and receiving third healthcare information each includes automatically receiving the corresponding healthcare information via a secure file transfer protocol process.

16. The method of claim 11, further comprising:
receiving fourth healthcare information associated with the patient from a fourth source, wherein the fourth healthcare information includes at least one patient assessment completed by the patient;
normalizing the fourth healthcare information into the predetermined format and storing the normalized fourth healthcare information with the normalized third healthcare information, the normalized second healthcare information and the normalized first healthcare information; and
automatically updating the patient risk level after the storing of the normalized fourth healthcare information.

17. The method of claim 16, further comprising providing a first interface to a healthcare provider to permit the healthcare provider to select the at least one assessment for the patient from a list of assessments displayed in the first interface.

18. The method of claim 17, further comprising providing a second interface to the patient to permit the patient to complete the at least one assessment selected by the healthcare provider, wherein the second interface sequentially displays questions for the patient.

19. The method of claim 11, further comprising providing an audit interface to permit a user to perform an audit on the normalized third healthcare information, the normalized second healthcare information and the normalized first healthcare information.

20. The method of claim 11, further comprising:
storing normalized third healthcare information, normalized second healthcare information and normalized first healthcare information for a plurality of patients;
performing a demographics analysis on the stored information for the plurality of patients; and
automatically updating the patient risk level after the performing the demographic analysis.
